(19) United States
(12) Patent Application Publication
(10) Pub. No.: US 2006/0268138 A1
(43) Pub. Date: Nov. 30, 2006

(54) Image signal processing unit, image pickup device including the same, and image signal processing method

(76) Inventor: Yoshihito Higashitsutsumi, Mizuho-shi (JP)

Correspondence Address: CANTOR COLBURN, LLP, 55 GRIFFIN ROAD SOUTH, BLOOMFIELD, CT, 06002, US

(21) Appl. No.: 11/432,052

(22) Filed: May 11, 2006

(30) Foreign Application Priority Data
May 13, 2005 (JP) 2005-141255
Jul. 29, 2005 (JP) 2005-219774

(51) Int. Cl. H04N 5/228; H04N 5/335

(52) U.S. Cl. 348/294; 348/208.99

(57) ABSTRACT

An image pickup element accumulates information charges in a plurality of potential wells substantially separated from one another during image pickup, transfers the information charges accumulated in at least one of the plurality of potential wells during the transfer, and outputs a compressed image signal, and an image signal processing section performs vibration reduction processing use of the compressed image signal.

### CROSS-REFERENCE TO RELATED APPLICATIONS

The entire disclosure of Japanese Patent Applications No. 2005-141255 and 2005-219774 including specifications, claims, drawings, and abstracts is incorporated herein by reference.

### BACKGROUND OF THE INVENTION

1. Field of the Invention

The present invention relates to an image signal processing unit which reduces vibrations for a picked-up image signal, an image pickup device including the unit, and an image signal processing method.

2. Description of the Related Art

There has been broadly used an image pickup device such as a digital still camera or a video camera in which a solid image pickup element is incorporated, such as a CCD solid image pickup element. Most of the image pickup devices have a function which reduces the effects of hand shake during image pickup with respect to the image signal obtained by the image pickup.

As vibration reduction processing, a processing method is known in which a degree of hand shake is detected by an acceleration sensor and the like disposed in the image pickup device, and a relative position of the image signal obtained by the image pickup is displaced in accordance with the degree of the hand shake. There is also disclosed a method of detecting movement of a characteristic portion between image frames to detect the degree of the hand shake from the movement of the portion.

When the movement of the characteristic portion is detected by comparing the plurality of image frames with one another, it is necessary to acquire the image signals of the plurality of image frames for use in the processing in a sufficiently short image pickup period. Specifically, it is preferable to acquire, in a period of about 0.6 seconds, the image signals of the plurality of image frames for use in the processing to detect the degree of hand shake.

However, in recent years, with increase of pixels for improvement of resolution of the solid image pickup element, transfer stages required until the image signal is output are increased, and it has become difficult to acquire the image signals of the plurality of image frames in a required time.

For example, in a case where four image frames are subjected to the vibration reduction processing in the CCD solid image pickup element of a frame transfer type, as shown in FIG. 21, an exposure time for the four image frames and a transfer time for three image frames are required during the image pickup for the four image frames. It is to be noted that when the fourth image frame is transferred, the transfer time of the fourth image frame does not raise any problem, because the image pickup of the fourth image frame has already been completed. For example, as shown in FIG. 21, assuming that a shutter speed Ts is 1/60 (0.017) of a second, a frame transfer time Tf is 0.45 seconds, and a grace period Tb of an electronic shutter or the like is 0.02 seconds, a time Tt for picking up the images of the four image frames is 4×0.017+3×(0.45+0.02)=about 1.48 seconds.

In a case where a time to acquire the image signals of the plurality of image frames lengthens in this manner, even if the movement of the characteristic portion is detected by comparing the plurality of image frames with one another, an influence (e.g., influence of movement of a subject itself) of a factor other than the hand shake increases, and precision of the vibration reduction drops. Therefore, an effect of the vibration reduction processing cannot be sufficiently obtained.

### SUMMARY OF THE INVENTION

The present invention is an image pickup device comprising: an image pickup element in which there is arranged a matrix of a plurality of pixels to generate and accumulate information charges in accordance with intensity of light incoming from the outside and which transfers and outputs the information charges accumulated in the pixels; and an image signal processing section which performs vibration reduction processing with respect to an image signal output from the image pickup element, wherein the image pickup element accumulates the information charges in a plurality of potential wells substantially separated from one another during image pickup, and transfers the information charges accumulated in at least one of the plurality of potential wells during the transfer to output the compressed image signal, and the image signal processing section performs the vibration reduction processing by use of the compressed image signal.

### BRIEF DESCRIPTION OF THE DRAWINGS

Preferred embodiments of the present invention will be described in detail based on the following drawings, wherein:

FIG. 1 is a diagram showing a constitution of an image pickup device in an embodiment of the present invention;

FIG. 2 is a plan view showing internal structure of an image pickup section and an accumulating section of a CCD solid image pickup element;

FIG. 3 is a sectional view showing the internal structure of the image pickup section and the accumulating section of the CCD solid image pickup element;

FIG. 4 is a sectional view showing the internal structure of the image pickup section and the accumulating section of the CCD solid image pickup element;

FIG. 5 is a plan view showing an arrangement of color filters in the image pickup section;

FIG. 6 is a plan view showing the color filters arranged in a mosaic form;

FIG. 7 is a timing chart during image pickup and vertical transfer in the embodiment of the present invention;

FIG. 8 is an explanatory view of a potential distribution during the image pickup and vertical transfer in the embodiment of the present invention;

FIG. 9 is a timing chart showing an electronic shutter during the image pickup in a modification of the present invention;

FIG. 10 is an explanatory view of a time for acquiring a plurality of image frames for use in vibration reduction processing in the embodiment of the present invention;

FIGS. 11A to 11C are explanatory views of thinning of pixels in the embodiment of the present invention;

FIG. 12 is a flowchart of the vibration reduction processing in the embodiment of the present invention;

FIG. 13 is a diagram showing an output signal of a compressed image frame in the embodiment of the present invention;

FIG. 14 is a diagram showing a result of filtering of the image frame shown in FIG. 13 in a horizontal direction;

FIG. 15 is a diagram showing a result of filtering of the image frame shown in FIG. 14 in a vertical direction;

FIG. 16 is a plan view showing internal structure of the accumulating section and a horizontal transfer section of the CCD solid image pickup element in the embodiment of the present invention;

FIG. 17 is a sectional view showing the internal structure of the accumulating section and the horizontal transfer section of the CCD solid image pickup element in the embodiment of the present invention;

FIG. 18 is a sectional view showing the internal structure of the accumulating section and the horizontal transfer section of the CCD solid image pickup element in the embodiment of the present invention;

FIG. 19 is a timing chart during horizontal transfer in the embodiment of the present invention;

FIG. 20 is a diagram showing a potential distribution during the horizontal transfer in the embodiment of the present invention;

FIG. 21 is an explanatory view of a time for acquiring a plurality of image frames for use in the vibration reduction processing of a background technology;

FIG. 22 is an explanatory view of a combination of pixels in the embodiment of the present invention;

FIG. 23 is an explanatory view of the combination of the pixels in the embodiment of the present invention;

FIGS. 24A to 24C are explanatory views of thinning of the pixels in the embodiment of the present invention;

FIG. 25 is a diagram showing an output signal of the compressed image frame in the embodiment of the present invention;

FIG. 26 is a diagram showing a result of filtering of the image frame shown in FIG. 25 in a vertical direction;

FIG. 27 is a diagram showing a result of filtering of the image frame shown in FIG. 26 in a horizontal direction;

FIG. 28 is a diagram showing a constitution of a solid image pickup device in a modification;

FIG. 29 is an enlarged view of a main constitution of a solid image pickup element in the modification;

FIG. 30 is a timing chart of a clock pulse which controls the solid image pickup element in the modification;

FIG. 31 is a timing chart of the clock pulse which controls the solid image pickup element in the modification;

FIG. 32 is a diagram showing a change of a potential of a horizontal transfer section in the modification; and

FIG. 33 is a timing chart showing a change of an output in the modification.

### DESCRIPTION OF THE PREFERRED EMBODIMENTS

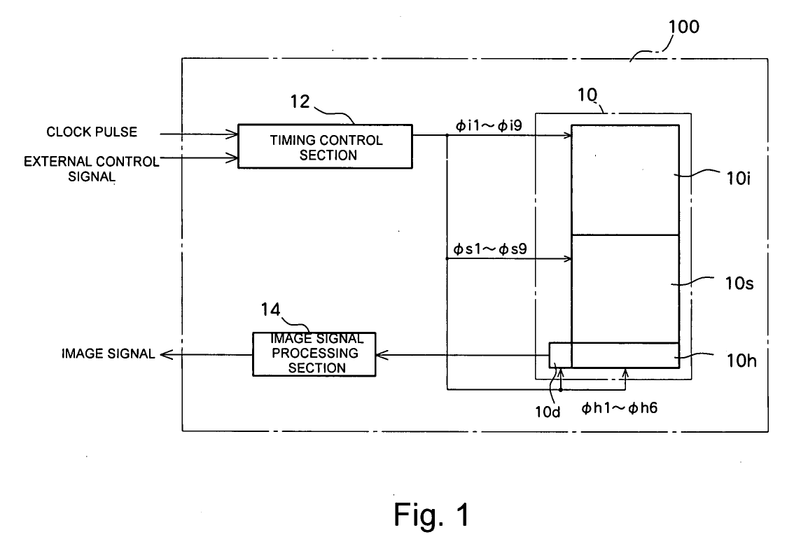

In an embodiment of the present invention, as shown in FIG. 1, an image pickup device 100 includes a solid image pickup element 10, a timing control section 12, and an image signal processing section 14.

Image pickup, transfer and output of the solid image pickup element 10 are performed by various clock pulses input from the timing control section 12. An image signal output from the solid image pickup element 10 is subjected to signal processing such as vibration reduction processing in the image signal processing section 14. One characteristic of the present embodiment lies in that image signals for at least one of a plurality of image frames for use in the vibration reduction processing are compressed and transferred to thereby shorten a time required for picking up an image.

The solid image pickup element 10 includes a CCD solid image pickup element, and light receiving pixels arranged in a matrix as in a CMOS solid image pickup element. The element can successively transfer information charges generated by the light receiving elements during the image pickup to output the image signals. The solid image pickup element 10 will be described hereinafter in accordance with an example of a frame transfer type CCD solid image pickup element, but the present invention is not limited to this example.

The solid image pickup element 10 includes an image pickup section 10i, an accumulating section 10s, a horizontal transfer section 10h, and an output section 10d.

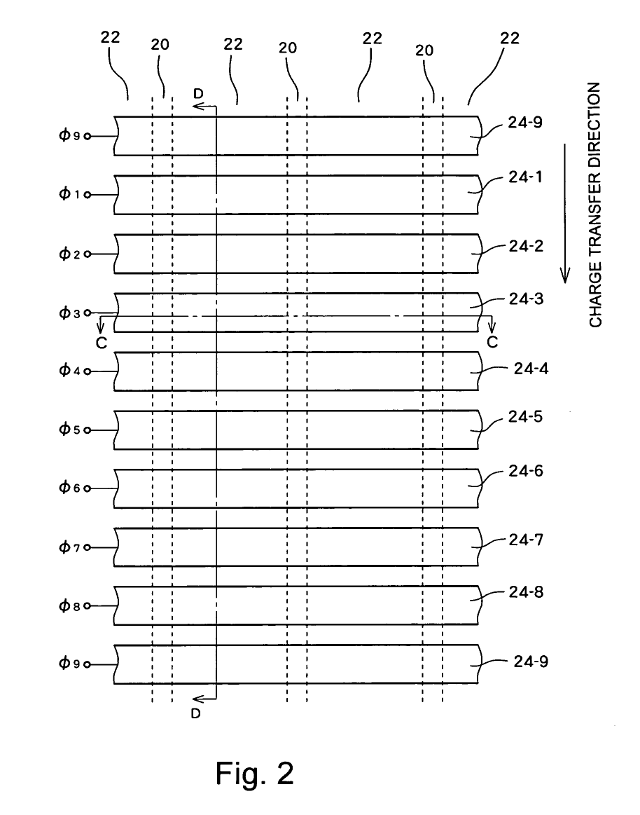

As shown in a plan view of the inside of the element shown in FIG. 2, the image pickup section 10i and the accumulating section 10s are constituted of a vertical shift register formed in a surface area of a semiconductor substrate. The accumulating section 10s includes the vertical shift register disposed continuously from the vertical shift register of the image pickup section 10i. The whole vertical shift register of the accumulating section 10s is shielded against light, and is used in accumulating information charges for one frame.

The vertical shift register can be constituted of: a plurality of channel regions 22 defined by isolation regions 20 extended in approximately parallel with one another toward a vertical direction (longitudinal direction of FIG. 2); and a plurality of transfer electrodes 24-1 to 24-9 intersecting with the channel regions 22.

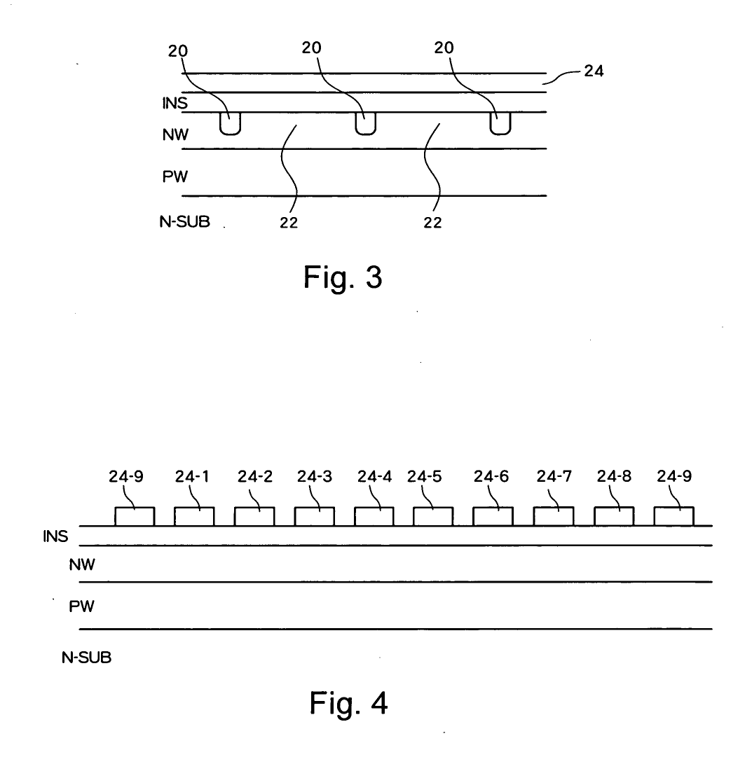

FIGS. 3 and 4 are sectional views cut along the lines C-C and D-D of FIG. 2, respectively. A P-well (PW) is formed in an N-type semiconductor substrate, and an N-well (NW) is formed on the P-well. Furthermore, the isolation regions 20 constituted of P-type impurity regions are formed at predetermined intervals in approximately parallel with one another in the N-well (NW). Each isolation region 20 forms a potential barrier between the adjacent channel regions 22. A region sandwiched between these isolation regions 20 is electrically defined, and each channel region 22 forms a transfer path of the information charges.

Moreover, an insulating film (INS) is formed on the surface of the semiconductor substrate. On this insulating film (INS), as shown in FIG. 2, a plurality of transfer electrodes 24 (24-1 to 24-9) formed of a polysilicon film or the like are repeatedly arranged in parallel with one another so as to cross an extending direction of the channel region 22 at right angles.

In the present embodiment, each of sets of three continuous transfer electrodes 24-1 to 24-3, 24-4 to 24-6 and 24-7 to 24-9 constitutes a light receiving pixel. The timing control section 12 applies transfer clocks φᵢ₁ to φᵢ₉ having a predetermined period to the transfer electrodes 24-1 to 24-9, respectively, to thereby transfer the information charge generated by the image pickup section 10i to the accumulating section 10s. The information charge buffered in the accumulating section 10s by applying the transfer clocks φᵢ₁ to φᵢ₉ is transferred to the horizontal transfer section 10h.

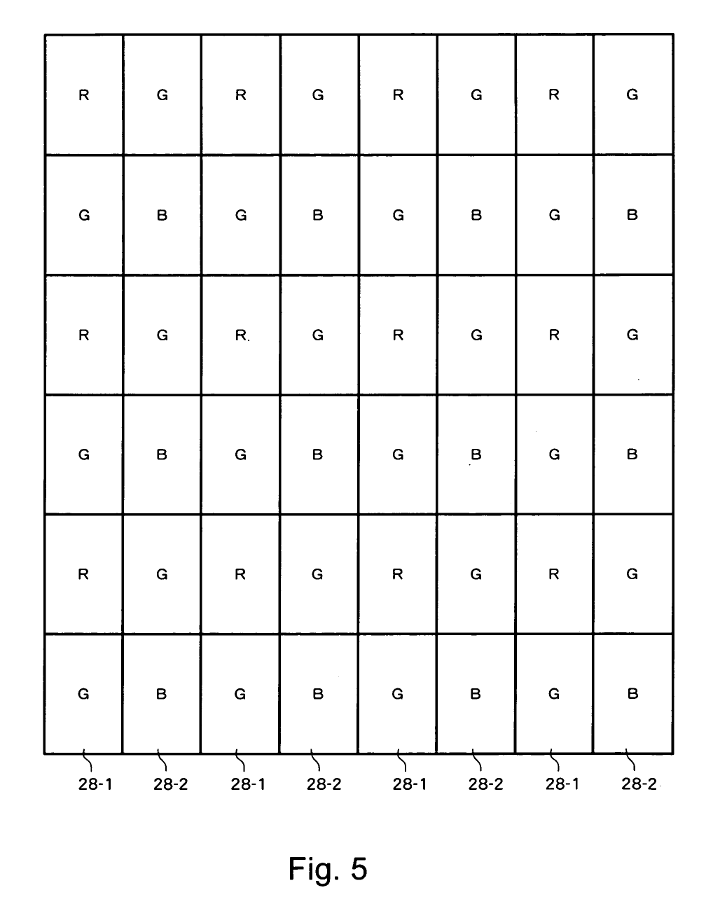

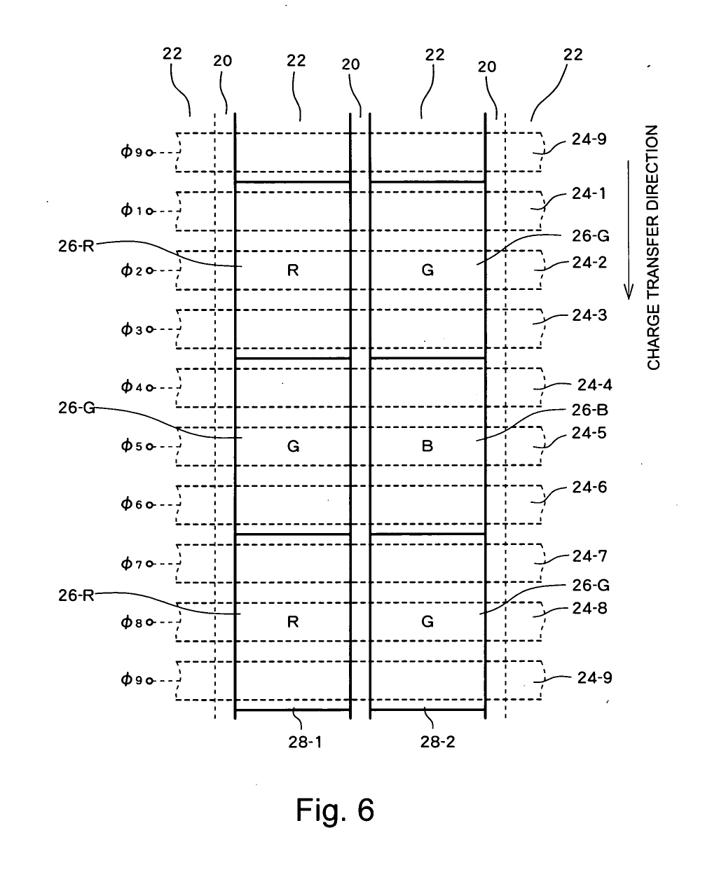

In the CCD solid image pickup element for developing a color image, as shown in FIG. 5, each light receiving pixel of an effective pixel region of the image pickup section 10i is covered with one of transmission filters 26-R, 26-G and 26-B arranged in a matrix form and corresponding to wavelengths of red (R), green (G) and blue (B). For example, as shown in FIG. 6, a column 28-1 is constituted by arranging the filter 26-R which transmits the red (R) and the filter 26-G which transmits the green (G) along a vertical transfer direction so that the filters are alternately superimposed on the light receiving pixels along the extending direction of the vertical shift register. A column 28-2 is constituted by arranging the filter 26-G which transmits the green (G) and the filter 26-B which transmits the blue (B) so that the filters are alternately superimposed on the light receiving pixels along the extending direction of the vertical shift register. The columns are alternately arranged in a direction crossing the vertical transfer direction at approximately right angles to thereby arrange the pixels corresponding to the wavelengths of the red (R), the green (G) and the blue (B) in a mosaic form. Consequently, the color image can be acquired.

Moreover, when an output control clock is applied from the timing control section 12 to the accumulating section 10s, the information charges held in the accumulating section 10s are transferred and output to the horizontal transfer section 10h every row of charges. The horizontal transfer section 10h includes a horizontal shift register. Each vertical shift register of the accumulating section 10s successively transfers and outputs the information charge for one pixel to each bit of the horizontal shift register of the horizontal transfer section 10h. The timing control section 12 inputs a horizontal clock pulse into the horizontal transfer section 10h. On receiving the horizontal clock pulse, the horizontal transfer section 10h transfers the information charges to the output section 10d every pixel. The output section 10d converts an amount of information charges for each pixel into a voltage value, and a change of the voltage value is output as a CCD output to the image signal processing section 14.

The timing control section 12 includes a timing pulse generation circuit. The timing control section 12 generates clock pulses such as a vertical clock pulse, a horizontal clock pulse, an output pulse and a reset pulse for controlling image pickup and information charge transfer in the solid image pickup element 10 based on a system clock, to output the pulse to each composition of the image pickup section 10. Every time the output section 10d outputs an output signal S of each pixel, the output section outputs a control clock pulse to the image signal processing section 14 in synchronization with a clock pulse such as the reset pulse. Consequently, output of the image signal from the solid image pickup element 10 can be synchronized with processing of the image signal in the image signal processing section 14 to perform the processing at an appropriate timing.

The image signal processing section 14 includes: a correlated double sampling portion (CDS portion); an analog amplifier (auto gain control: AGC); an analog/digital converter (A/D converter); and a vibration reducing portion. Since the processing in the CDS portion, the analog amplifier and the analog/digital converter is similar to existing technology, description herein is omitted. The processing of the vibration reducing portion will be described later.

<Vertical Compression Transfer of Image Signal>

In the present embodiment, a group of pixels is regarded as one set, the pixels being included in a period obtained by adding one pixel to a period in which the pixels corresponding to the same wavelength region (color) are arranged along the vertical transfer direction. Different clock pulses are supplied to the transfer electrodes included in one set to thereby control the set. For example, for the pixel arrangement of FIG. 5, since the pixels corresponding to the same color (R, G, and B) wavelength region are arranged along the vertical transfer direction in a period of two pixels, the transfer electrodes for two pixels+one pixel=three pixels are regarded as one set and controlled. That is, as shown in FIG. 6, nine transfer electrodes 24-1 to 24-9 continuously arranged along a transfer direction are regarded as one set, different clock pulses are supplied to the transfer electrodes 24-1 to 24-9, and the transfer electrodes 24-1 to 24-9 arranged in three pixels continuously along the vertical transfer direction are individually controlled.

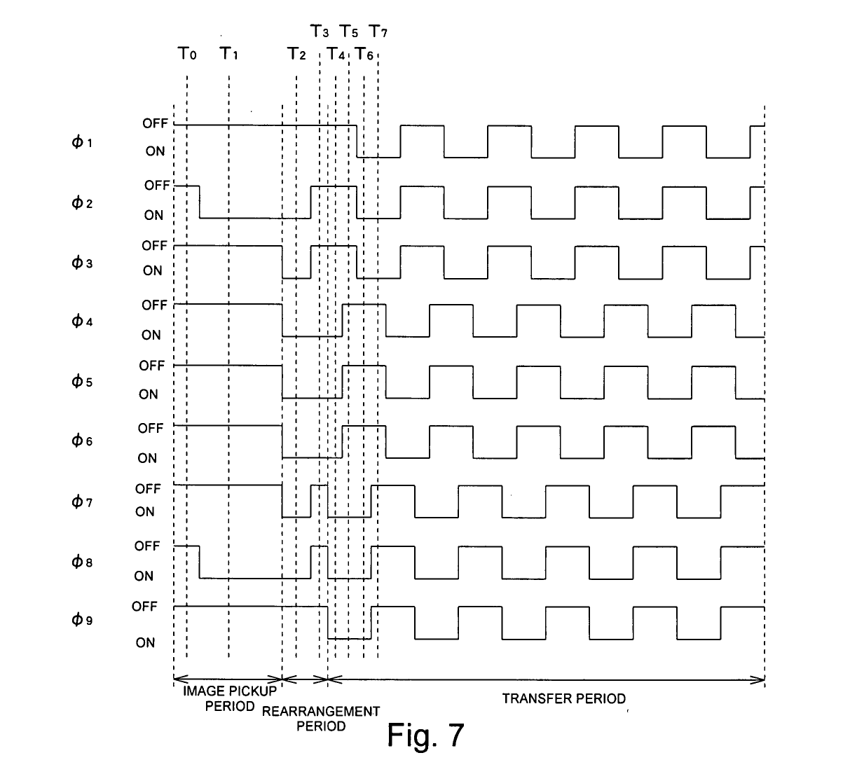

In the image pickup device 100, the image pickup (accumulation of the information charges) and the transfer of the information charges can be performed by controlling voltages to be applied from the timing control section 12 to the transfer electrodes 24-1 to 24-9. This control of the transfer electrodes will be described with reference to a timing chart of FIG. 7 from the image pickup until the transfer. The accumulating section 10s is controlled during the transfer in the same manner as in the image pickup section 10i during the transfer.

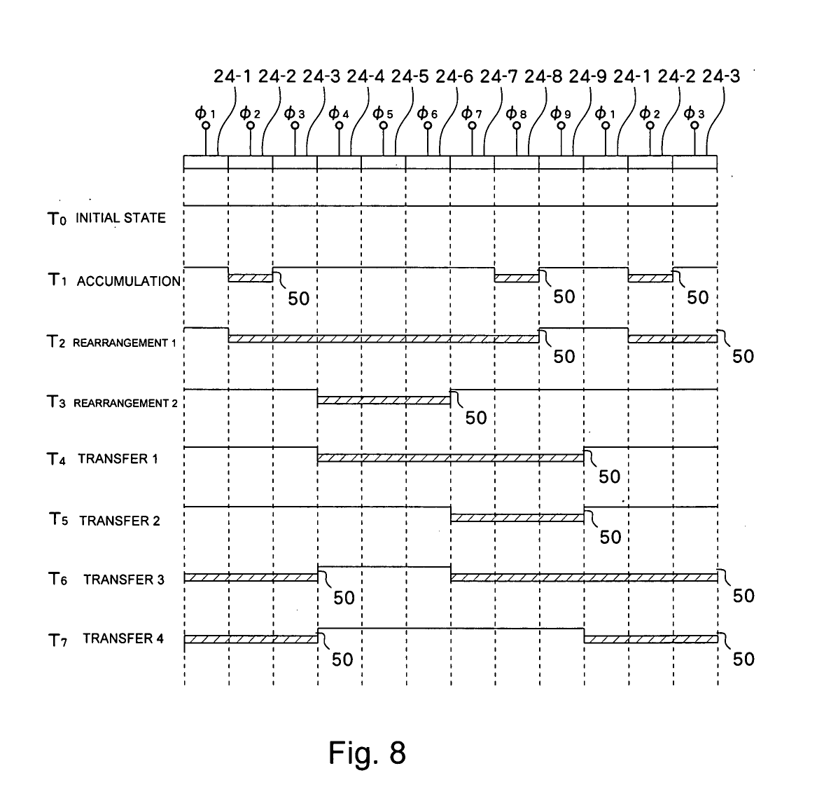

Moreover, FIG. 8 shows a behavior of a change of a potential in each of the transfer electrodes 24-1 to 24-9 for time T₀ to T_{g}. The abscissa indicates positions along the vertical transfer direction in the image pickup section 10i, and the ordinate indicates potentials of the respective positions. At this time, a lower part of the drawing indicates a positive potential side, and an upper part thereof indicates a negative potential side.

The timing control section 12 applies the clock pulses φᵢ₁ to φᵢ₉ to the transfer electrodes 24-1 to 24-9, respectively. The semiconductor substrate of the solid image pickup element 10 is fixed at a substrate potential Vsub.

The time T₀ indicates an initial state before the image pickup. At this time, all of the clock pulses φᵢ₁ to φᵢ₉ are turned off. As shown in FIG. 8, no potential well is formed under the transfer electrodes 24-1 to 24-9, and the electric charges are discharged to the substrate.

At the time T₁, the clock pulse is controlled so that the potential wells are formed in the pixels of opposite ends of the pixel group regarded as one set. Here, the clock pulses φᵢ₂, φᵢ₈ are turned on, and the potential wells are formed under the transfer electrodes 24-2 and 24-8. In these potential wells, there are accumulated the information charges generated in response to light which has struck around the transfer electrodes 24-2 and 24-8 which have been turned on.

In the present embodiment, the pixels of the period obtained by adding one pixel to the period in which the pixels corresponding to the same wavelength region are arranged along the transfer direction are regarded as one set when controlling the clock pulses to be supplied to the transfer electrodes. Therefore, the information charges generated with respect to the same wavelength component are accumulated in one set of pixels. For example, in the column 24-1 shown in FIG. 3, a set of R, G and R and a set of G, R and G are repeatedly arranged from the left. The information charges generated with respect to a red wavelength component are accumulated in the pixels corresponding to R of opposite ends of the set of R, G and R, and the information charges generated with respect to a green wavelength component are accumulated in the pixels corresponding to G of opposite ends of the set of G, R and G. In the column 24-2, a set of G, B and G and a set of B, G and B are repeatedly arranged from the left. The information charges generated with respect to the green wavelength component are accumulated in the pixels corresponding to G of opposite ends of the set of G, B and G, and the information charges generated with respect to a blue wavelength component are accumulated in the pixels corresponding to B of opposite ends of the set of B, G and B.

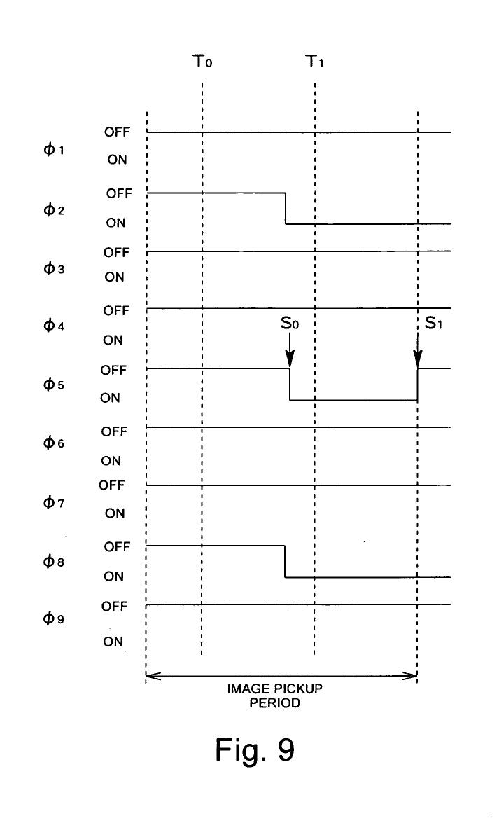

Here, the pixels other than the opposite-end pixels are controlled so that the clock pulses are maintained to be off to thereby constantly discharge the information charges to the substrate, but the present invention is not limited to this control. For example, as shown in FIG. 9, the clock pulse φᵢ₅ is temporarily turned on together with the clock pulses φᵢ₂ and φᵢ₈ to accumulate the information charges at time S₀. At time S₁ when the image pickup ends, the clock pulse φᵢ₅ is turned off to discharge the information charges. Accordingly, an electronic shutter operation may be performed.

The information charges are rearranged for a time T₂ and T₃. The information charges accumulated in the potential wells of the pixels of the opposite ends of one set of pixels are collected in one potential well. At time T₂, the clock pulses φᵢ₃ to φᵢ₇ are turned on in addition to the clock pulses φᵢ₂ and φᵢ₈, and the information charges accumulated in the potential wells under the transfer electrodes 24-2 and 24-8 are added and synthesized. Subsequently, at time T₃, the clock pulses φᵢ₂, φᵢ₃, φᵢ₇ and φᵢ₈ are turned off, and the information charges are rearranged in the potential wells formed under the transfer electrodes 24-4 to 24-6.

At and after time T₄, the information charges collected in one potential well are transferred to one set of pixels. At this time, in-phase clock pulses are supplied to at least two transfer electrodes arranged continuously along the transfer direction to thereby transfer the charges. Here, the charges are transferred by supplying the in-phase clock pulse to each set of three transfer electrodes disposed for each pixel.

In the present embodiment, as shown in FIG. 7, each of the clock pulse sets φᵢ₁ to φᵢ₃, φᵢ₄ to φᵢ₆ and φᵢ₇ to φᵢ₉ is driven in phase. As shown in FIG. 8, each of continuously arranged transfer electrode sets 24-1 to 24-3, 24-4 to 24-6 and 24-7 to 24-9 is regarded as a transfer unit, and the information charges are successively transferred to the sets.

Specifically, as shown in FIG. 7, the clock pulses φᵢ₁ to φᵢ₃ are turned off and the clock pulses φᵢ₄ to φᵢ₉ are turned on at time T₄, and the clock pulses φᵢ₁ to φᵢ₆ are turned off and the clock pulses φᵢ₇ to φᵢ₉ are turned on at time T₅. Accordingly, as shown in FIG. 8, the information charges accumulated in the potential well formed under the transfer electrodes 24-4 to 24-6 are transferred to a potential well newly formed under the transfer electrodes 24-7 to 24-9. The clock pulses φᵢ₄ to φᵢ₆ are turned off and the clock pulses φᵢ₁ to φᵢ₃ and φᵢ₇ to φᵢ₉ are turned on at time T₆, and the clock pulses φᵢ₄ to φᵢ₉ are turned off and the clock pulses φᵢ₁ to φᵢ₃ are turned on at time T₇. Accordingly, as shown in FIG. 8, the information charges accumulated in the potential well formed under the transfer electrodes 24-7 to 24-9 are transferred to a potential well newly formed under the transfer electrodes 24-1 to 24-3. Similarly, the in-phase clock pulses can be applied to each set of transfer electrodes arranged in one pixel to thereby successively transfer the information charges. This transfer also applies to another column. Even in the accumulating section 10s, the clock pulses φᵢ₁ to φᵢ₉ can similarly be applied to thereby transfer the information charges in the vertical transfer direction.

As described above, during the transfer, a plurality of transfer electrodes are regarded as one set and controlled, whereby the image signal of the image pickup section 10i can be compressed in the vertical transfer direction and transferred at a high speed. For example, when three transfer electrodes are compiled into one set and controlled as in the present embodiment, the frame transfer time Tf can be reduced to about ⅓ of a conventional frame transfer time. Assuming that the conventional frame transfer time Tf in a case where the signal is not compressed is 0.45 seconds, the frame transfer time Tf can be reduced to about 0.15 seconds in a case where the signal is compressed as in the present embodiment.

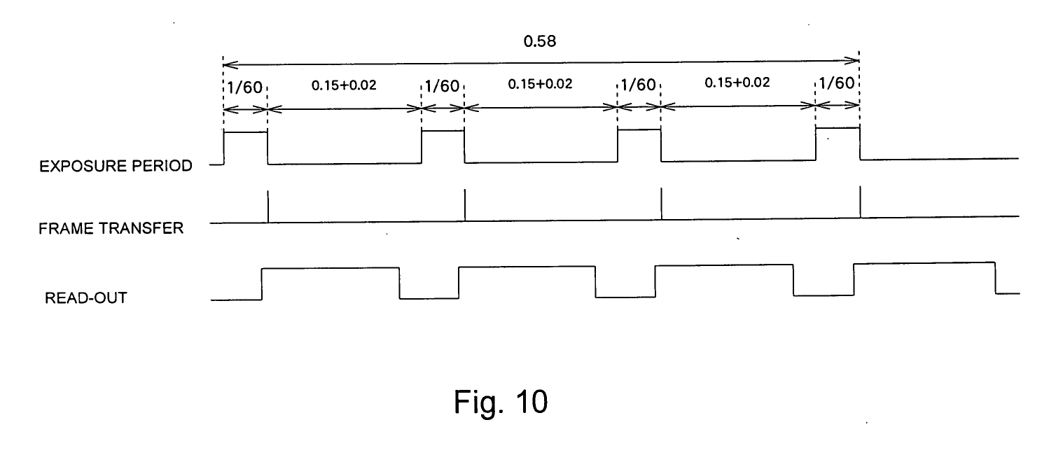

Consequently, in a case where four image frames are subjected to the vibration reduction processing, as shown in FIG. 10, when the shutter speed Ts is 1/60 (0.017) second and the grace period Tb of the electronic shutter or the like is 0.02 seconds, a time Tt for picking up the images in the four image frames is 4×0.017+3×(0.15+0.02)=about 0.58 seconds. Therefore, the image can be picked up in 0.6 seconds in response to the image signal for a plurality of image frames for use in detecting a degree of hands movement.

As described above, the image signal processing section (image signal processing element) performs the vibration reduction processing with respect to the image signal output from the image pickup section in which a plurality of pixels are arranged in the matrix to accumulate the information charges in a plurality of potential wells isolated substantially from one another in accordance with the intensity of light incoming from the outside during the image pickup. The section performs the vibration reduction processing by use of the compressed image signal obtained from the information charges accumulated in at least one of a plurality of potential wells.

In this image pickup device, in a case where the image signal processing section performs the vibration reduction processing with respect to the image signal output from the image pickup element including the image pickup section in which the plurality of pixels are arranged in the matrix to accumulate the information charges in the plurality of potential wells isolated substantially from one another in accordance with the intensity of the light incoming from the outside during the image pickup, the vibration reduction processing is performed using the compressed image signal synthesized by adding up the information charges accumulated in at least two of the plurality of potential wells.

As described above, when the compressed image signal of the image frame is used in the vibration reduction processing, the time required for picking up the image can be shortened. Therefore, the influence of movement other than the hand shake, such as the movement of the subject itself, can be eliminated, and the vibrations can be reduced with a high precision.

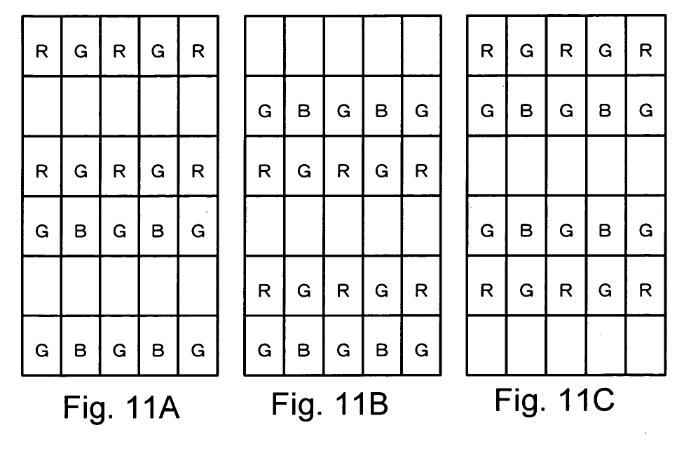

Moreover, it is preferable that the transfer electrode to be turned on during the image pickup is changed every frame. For example, in a case where three pixels arranged continuously along the vertical transfer direction are regarded as one set as in the present embodiment, the pixel in which the information charge is to be accumulated during the image pickup is changed every image pickup. Specifically, in a case where four image frames are subjected to the vibration reduction processing, when the first image frame is picked up, as shown in FIG. 11A, only pixels corresponding to the transfer electrodes 24-4 to 24-6 are turned off, and no information charge is accumulated in the electrode by the electronic shutter operation, and the information charges accumulated in the transfer electrodes 24-1 to 24-3 and those accumulated in the transfer electrodes 24-7 to 24-9 are added up, synthesized and transferred. When the second image frame is picked up, as shown in FIG. 11B, only pixels corresponding to the transfer electrodes 24-1 to 24-3 are turned off, and no information charge is accumulated by the electronic shutter operation, and the information charges accumulated in the adjacent sets of the transfer electrodes 24-7 to 24-9 and 24-4 to 24-6 are added up, synthesized and transferred. When the third image frame is picked up, as shown in FIG. 1C, only pixels corresponding to the transfer electrodes 24-7 to 24-9 are turned off, and no information charge is accumulated by the electronic shutter operation, and the information charges accumulated in the adjacent sets of the transfer electrodes 24-4 to 24-6 and 24-1 to 24-3 are added up, synthesized and transferred. Moreover, since the transfer time does not raise any problem with respect to the image signal of the last image frame for use in the vibration reduction processing, that is, the fourth image frame, the image signal is not compressed, and is picked up and transferred as an image signal of a full screen without adding up or synthesizing the information charges.

As described above, the pixel whose information charge is to be thinned is changed with the image frame during the compressing of the image signal in the vertical direction. Accordingly, the positions of the pixels to be interpolated in the vibration reduction processing can be averaged spatially as described later. Therefore, it is possible to prevent the image from being deteriorated in the vibration reduction processing.

As described above, it is preferable that the vibration reduction processing is performed by use of a plurality of image frames output from the image pickup element. The plurality of image frames include preferably at least one compressed image frame, more preferably a plurality of compressed image frames.

When a plurality of image frames, including the image signal of at least one compressed image frame, are used in the vibration reduction processing, the vibrations can be more appropriately reduced by use of the image frame picked up in a short time. Especially in a case where the vibration reduction processing is performed by use of the image signals of the plurality of compressed image frames, the time required for the image pickup can be further shortened compared with a case where the same number of image frames are picked up without being compressed. Therefore, the influence other than that of the hand shake can further be eliminated, and precision of the vibration reduction can be improved.

Moreover, it is preferable to output the image signal compressed by successively changing the pixel to be removed from the set of pixels. In a case where the pixel whose information charge is to be thinned during the compressing of the image signal is changed with each image frame in this manner, the positions of the pixels to be interpolated in the vibration reduction processing can be averaged spatially. Therefore, the image can be prevented from being deteriorated in the vibration reduction processing.

Needless to say, the number of the image frames for use in the vibration reduction processing is not limited to four. It is preferable that the position of the pixel whose information charge is to be thinned and a ratio between the image frames to be compressed and the image frames which are not to be compressed are adjusted in accordance with the number of the pixel frames for use in the vibration reduction processing and a total time Tt to pick up the pixel frame for use in the vibration reduction processing.

Moreover, in the present embodiment, nine continuous transfer electrodes 24-1 to 24-9 are regarded as one set, and different clock pulses are supplied to the transfer electrodes 24-1 to 24-9, respectively. This controls the image pickup (accumulation of the information charges) and the transfer of the information charges in the image pickup section 10i. However, needless to say, the information charges may be transferred without being compressed, in the same manner as in the conventional technology. That is, the transfer electrodes 24-1 to 24-3, 24-4 to 24-6, or 24-7 to 24-9 are regarded as one set corresponding to one pixel, and the transfer electrodes 24-1, 24-4 and 24-7, the transfer electrodes 24-2, 24-5 and 24-8, and the transfer electrodes 24-3, 24-6 and 24-9 may be controlled by the in-phase clock pulses, respectively. When control of a set of transfer electrodes corresponding to a plurality of continuous pixels and a control of a set of transfer electrodes corresponding to one pixel are switched, the image pickup and transfer can be switched between a case where the vibration reduction processing is performed and a case where no vibration reduction processing is performed.

It is to be noted that in the present embodiment, nine transfer electrodes are regarded as one set, and controlled by supplying nine different clock pulses, but the present invention is not limited to this example. For example, controllable clock pulses may be increased, whereby a more compressed image can be transferred at a higher speed. In the present embodiment, two pixels corresponding to the same wavelength component are added up and synthesized to obtain the compressed image. However, among, for example, three pixels in a case where nine transfer electrodes are regarded as one set, the information charges accumulated in two pixels may be discharged, and the information charge of the remaining pixel may be transferred to obtain the compressed image.

<Vibration Reduction Processing>

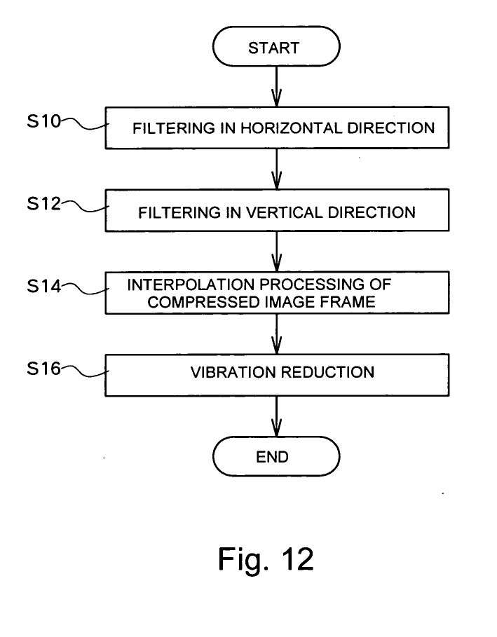

Next, the vibration reduction processing in the image signal processing section 14 will be described. The vibration reduction processing is performed in accordance with a flowchart shown in FIG. 12. The vibration reduction processing is realized by: extracting an image characteristic portion from a plurality of image frames for use in the processing; comparing positions of the characteristic portions among the plurality of image frames to thereby obtain a position deviation amount in each image frame; and reducing the position deviation amount in each image frame to add up and synthesize the plurality of image frames.

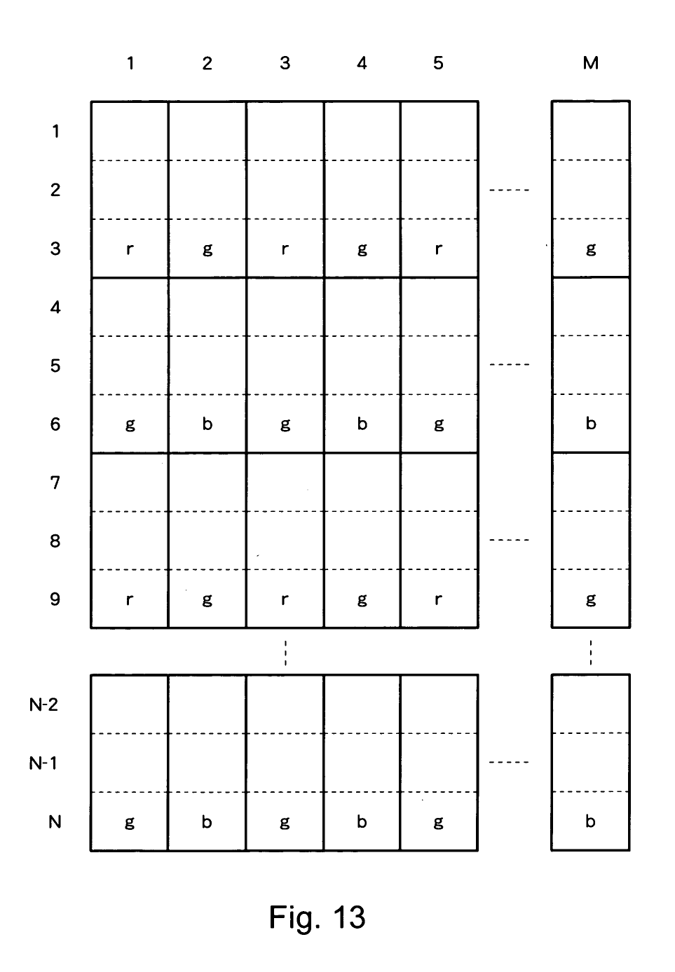

There will be described a case where three pixels continuously arranged along the vertical direction are regarded as a set, and the image signal compressed by adding up and synthesizing the information charges of the sets is output as shown in, for example, FIG. 13.

In step S10, the image frame is filtered in a horizontal direction based on an output value of each pixel of the compressed image frame, and wavelength components of red (R), green (G) and blue (B) with respect to each pixel are calculated. The pixel included in the compressed image frame is successively selected as a noted pixel constituting a calculation object, and a filtering coefficient is multiplied by the pixel which exists in a predetermined region from the noted pixel in the horizontal direction (row direction). An average value of a multiplication result is calculated to thereby calculate each wavelength component with respect to the noted pixel. All of the compressed image frames are filtered among a plurality of image frames for use in the vibration reduction processing.

For example, in a case where three pixels arranged continuously along the horizontal direction are filtered as a processing object, assuming that a pixel (n, m) of an n-th row and an m-th column is the noted pixel, a wavelength component Rh_{n, m} of the red (R) with respect to the pixel (n, m) can be calculated by Rh_{n, m}=(α×r_{n, m-1}+β×r_{n, m}+γ×r_{n, m+1})/β. Here, it is assumed that (α, β, γ) are filtering coefficients, α=β/2, γ=β/2, and rᵢⱼ is a wavelength component of the red (R) of the output signal in the pixel (i, j). Similarly, a wavelength component Gh_{n, m} of the green (G) with respect to the pixel (n, m) can be calculated by Gh_{n, m}=(α×g_{n, m-1}+β×g_{n, m}+γ×g_{n, m+1})/β, wherein gᵢⱼ is a wavelength component of the green (G) of the output signal in the pixel (i, j). A wavelength component Bh_{n, m} of the blue (B) with respect to the pixel (n, m) can be calculated by Bh_{n, m}=(α×b_{n, m-1}+β×b_{n, m}+γ×b_{n, m+1})/β, wherein bᵢⱼ is a wavelength component of the blue (B) of the output signal in the pixel (i, j).

Specifically, there will be described a case where the filtering coefficients (α, β, γ)=(1, 2, 1). It is assumed that a pixel (3, 2) is a noted pixel in a third row in which the information charges of the red (R) and the green (G) are alternately arranged. The wavelength component Rh_{3, 2} of the red (R) with respect to the noted pixel (3, 2) is Rh_{3, 2}=(1×r_{3, 1}+2×r_{3, 2}+1×r_{3, 3})/2=(r_{3, 1}+r_{3, 3})/2. That is, since a wavelength component r_{3, 2} of the red (R) in the noted pixel (3, 2) is 0, an average value of output values r_{3, 1} and r_{3, 3} corresponding to the wavelength component of the red (R) in pixels (3, 1) and (3, 3) adjacent to the noted pixel (3, 2) is a wavelength component Rh_{3, 2} of the red (R) with respect to the noted pixel (3, 2). The wavelength component Gh_{2, 3} of the green (G) with respect to the noted pixel (3, 2) is Gh_{2, 3}=(1×g_{2, 2}+2×g_{2, 3}+1×g_{2, 4})/2=g_{2, 3}. That is, since output values g_{3, 1} and g_{3, 3} corresponding to the wavelength component of the green (G) in the pixels (3, 1) and (3, 3) adjacent to the noted pixel (3, 2) are 0, a wavelength component g_{3, 2} of the green (G) in the noted pixel (3, 2) is a wavelength component Gh_{2, 3} of the green (G) in the noted pixel (3, 2). The wavelength component Bh_{2, 3} of the blue (B) is Bh_{2, 3}=(1×b_{2, 2}+2×b_{2, 3}+1×b_{2, 4})/2=0. That is, since output values b_{3, 1}, b_{3, 2} and b_{3, 3} corresponding to the wavelength component of the blue (B) in all of the pixels (3, 1), (3, 2) and (3, 3) constituting filtering objects are 0, the wavelength component Bh_{2, 3} of the blue (B) with respect to the noted pixel (3, 2) is also 0. Another pixel is similarly processed.

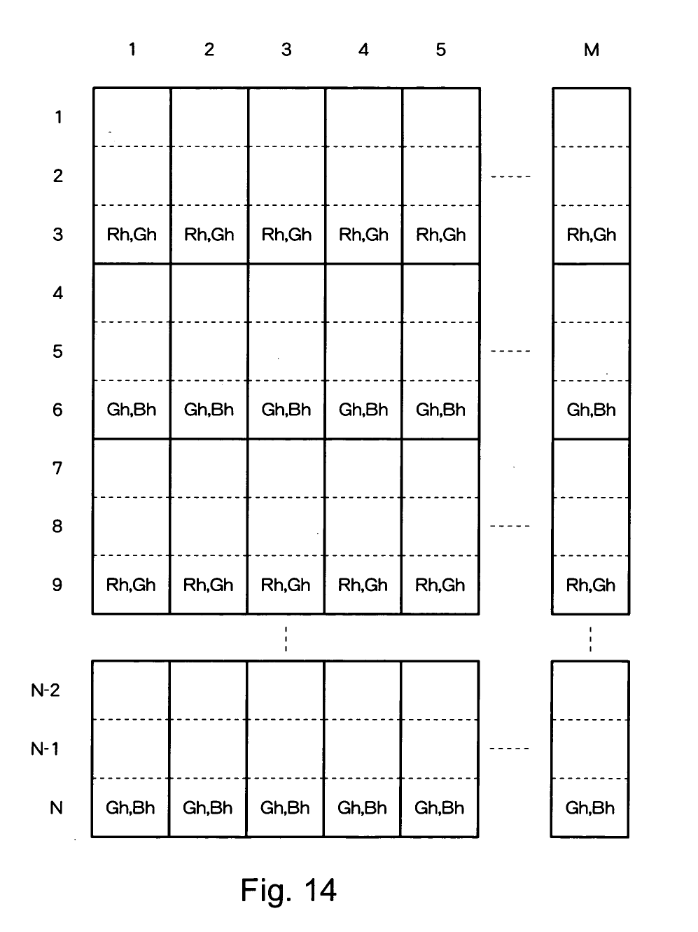

Since the filtering is performed in the horizontal direction, as shown in FIG. 14, the wavelength components Rh, Gh of the red (R) and green (G) with respect to each pixel are calculated in a row (e.g., the third row) in which the wavelength components r, g of the red (R) and green (G) are alternately output, and the wavelength components Gh, Bh of the green (G) and blue (B) with respect to each pixel are calculated in a row in which the wavelength components g, b of the green (G) and blue (B) are alternately output.

It is to be noted that the filtering in step S10 is not limited to this example, and the filtering or the like may be performed using pixel values of more pixels, such as pixel values of five pixels from the noted pixel in the horizontal direction. It is preferable that the filtering coefficient is appropriately adjusted.

In step S12, the filtering is performed in a vertical direction based on the output value of each pixel of the compressed image frame, and the wavelength components of the red (R), green (G) and blue (B) with respect to each pixel are calculated. The pixel included in the compressed image frame is successively selected as the noted pixel constituting the calculation object, and the filtering coefficient is multiplied by the pixel which exists in the predetermined region from the noted pixel in the vertical direction (column direction). The average value of the multiplication results is calculated to thereby calculate each wavelength component with respect to the noted pixel. All of the compressed image frames are filtered among the plurality of image frames for use in the vibration reduction processing.

The filtering is performed on all of the wavelength components of each noted pixel. That is, for the pixel whose wavelength components Rh and Gh of the red (R) and green (G) have already been calculated, the wavelength components of the red (R) and green (G) are filtered in the vertical direction to thereby average random noise. Moreover, the wavelength component of the blue (B), which has not yet been calculated, is calculated. Similarly, for the pixel whose wavelength components Gh and Bh of the green (G) and blue (B) have already been calculated, the wavelength components of the green (G) and blue (B) are filtered in the vertical direction to thereby average the random noise. Moreover, the wavelength component of the red (R) which has not been calculated yet, is calculated.

In a case where seven pixels arranged continuously in the vertical direction are regarded as a processing object, and filtered, assuming that the pixel (n, m) of the n-th row and the m-th column is the noted pixel, a wavelength component R_{n, m} of the red (R) with respect to the pixel (n, m) can be calculated by R_{n, m}=(δ×Rh_{n-3, m}+ε×Rh_{n, m}+ζ×Rh_{n+3, m})/(δ+ε+ζ)/2. Here, it is assumed that (δ, ε, ζ) is a filtering coefficient, δ=ζ, and Rhᵢⱼ is a red (R) wavelength component of the pixel (i, j) filtered in the horizontal direction. Similarly, a wavelength component G_{n, m} of the green (G) with respect to the pixel (n, m) can be calculated by G_{n, m}=(δ×Gh_{n-3, m}+ε×Gh_{n, m}+ζ×Gh_{n+3, m})/(δ+ε+ζ), wherein Ghᵢⱼ is a wavelength component of the green (G) of the pixel (i, j) filtered in the horizontal direction. A wavelength component B_{n, m} of the blue (B) with respect to the pixel (n, m) can be calculated by B_{n, m}=(δ×Bh_{n-3, m}+ε×Bh_{n, m}+ζ×Bh_{n+3, m})/(δ+ε+ζ)/2, wherein Bhᵢⱼ is a wavelength component of the blue (B) of the pixel (i, j) filtered in the horizontal direction.

Specifically, there will be described a case where the filtering coefficients (δ+ε+ζ)=(1, 2, 1). It is assumed that a pixel (6, 1) is a noted pixel in a sixth column. The wavelength component R_{6, 1} of the red (R) with respect to the noted pixel (6, 1) is R_{6, 1}=(Rh_{3, 1}+Rh_{9, 1})/2. That is, since a wavelength component Rh_{6, 1} of the red (R) in the noted pixel (6, 1) is 0, an average value of the wavelength components Rh_{3, 1} and Rh_{9, 1} of the red (R) in pixels (3, 1) and (9, 1) is a wavelength component R_{6, 1} of the red (R) with respect to the noted pixel (6, 1). This also applies to another pixel: the wavelength component G_{6, 1} of the green (G) is G_{6, 1}=(Gh_{3, 1}+2×Gh_{6, 1}+Gh_{9, 1})/4; and the wavelength component B_{6, 1} of the blue (B) is B_{6, 1}=Bh_{6, 1}.

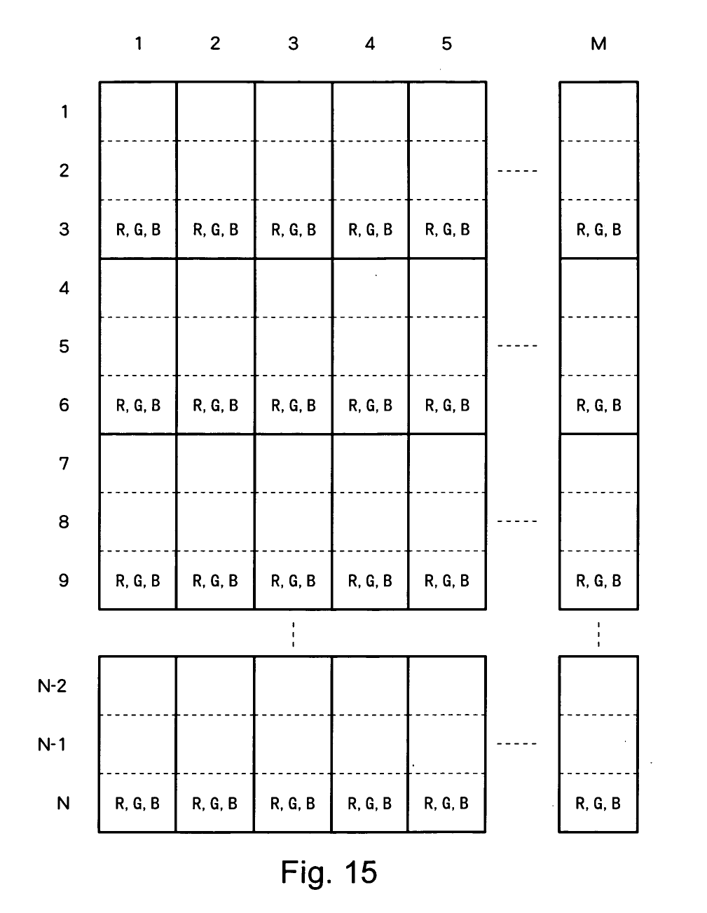

When the filtering is performed in the vertical direction, as shown in FIG. 15, the wavelength components R, G and B of the red (R), green (G) and blue (B) with respect to a plurality of pixel sets are obtained, and the random noise can be averaged.

It is to be noted that the filtering in step S12 is not limited to this example, and the filtering or the like may be performed using pixel values of more pixels, such as pixel values of 13 pixels from the noted pixel in the vertical direction. It is preferable that the filtering coefficients are appropriately adjusted. Furthermore, after the filtering in the vertical direction in the step S12, the filtering of the step S10 may be performed in the horizontal direction.

In step S14, interpolation processing is performed to convert the compressed image frame into an image frame of all pixels (full image). That is, a pixel which does not have any value owing to the compression is interpolated based on each wavelength component of the pixels in the vicinity. At this time, linear interpolation processing is preferably performed in consideration of weighting in accordance with a distance from the pixel which is a calculation object of an interpolated value. The interpolation processing is performed on all of the compressed image frames among a plurality of image frames for use in the vibration reduction processing.

For example, in a case where a pixel (3p, q) has a pixel value every three rows as shown in FIG. 15, an interpolated value R_{3p 1, q} of the red wavelength component of the pixel (3p−1, q) can be calculated as R_{3p-1, q}=(ζ×R_{3p-3, q}+η×R_{3p, q})/(ζ+η). An interpolated value R_{3p+1, q} of the red wavelength component of the pixel (3p+1, q) can be calculated as R_{3p+1, q}=(η×R_{3p, q}+ζ×R_{3p+3, q})/(ζ+η). Another wavelength component can be similarly interpolated. Here, p and q are arbitrary integers, and (ζ, η) are weight coefficients of the interpolation processing.

Specifically, there will be described interpolation processing in which weight coefficients (ζ, η)=(1, 2) are assumed with respect to the image frame filtered as shown in FIG. 15. A wavelength component R_{4, 1} of the red (R) with respect to the pixel (4, 1) which does not have any pixel value is interpolated as R_{4, 1}=R_{3p+1, 1}=(2×R_{3, 1}+1×R_{6, 1})/3, wherein p=1. Similarly, a wavelength component G_{4, 1} of the green (G) can be interpolated as G_{4, 1}=G_{3p+1, 1}=(2×G_{3, 1}+1×G_{6, 1})/3, and a wavelength component B_{4, 1} of the blue (B) can be interpolated as B_{4, 1}=B_{3p+1, 1}=(2×B_{3, 1}+1×B_{6, 1})/3. A wavelength component R_{5, 1} of the red (R) with respect to the pixel (5, 1) which does not have any pixel value is interpolated as R_{5, 1}=R_{3p-1, 1}=(1×R_{3, 1}+2×R_{6, 1})/3, wherein p=2. Similarly, a wavelength component G_{5, 1} of the green (G) can be interpolated as G_{5, 1}=G_{3p-1, 1}=(1×G_{3, 1}+2×G_{6, 1})/3, and a wavelength component B_{5, 1} of the blue (B) can be interpolated as B_{5, 1}=B_{3p-1, 1}=(1×B_{3, 1}+2×B_{6, 1})/3.

When all of the pixels that do not have any wavelength component (pixel value) are subjected to the interpolation processing, the image frames of all of the pixels (full image) can be obtained from the compressed frame.

In step S16, the vibration reduction processing is performed based on a plurality of image frames. In the vibration reduction processing, it is possible to apply the existing processing described in Japanese Patent Application Laid-Open No. 2001-24933.

For example, the vibrations can be reduced by: extracting a characteristic region such as a high-luminance region from each of the plurality of image frames; obtaining a relative position deviating amount among the respective image frames based on a change of the position of the extracted characteristic region; and correcting the position of the image signal of each image frame based on the position deviating amount to add up and synthesize the signals.

Moreover, when each image frame is divided into blocks of 8×8 or 16×16 pixels, and a search region is determined in matching the blocks, the position deviation amount can be obtained. When a relative position deviation amount of each image frame with respect to another image frame is obtained, and the position of the image signal of each image frame is corrected, the vibrations can be reduced.

As described above, when the compressed image frame is subjected to extension processing by the filtering and interpolation processing, and returned to the image frame of all the pixels, the vibration reduction processing can be performed. In this case, a vertical transfer time can be shortened, and the vibration reduction processing can be appropriately performed. It is to be noted that the extension processing of the compressed image frame is not limited to a combination of the filtering and the interpolation processing, and can be appropriately changed in accordance with a driving method of the solid image pickup element.

<Horizontal Compression Transfer of Image Signal>

As described above, the vibration reduction processing can be performed using the image signal compressed in the vertical direction, but when the image signal is compressed in the horizontal direction, and output, a time required for the image pickup can be further shortened.

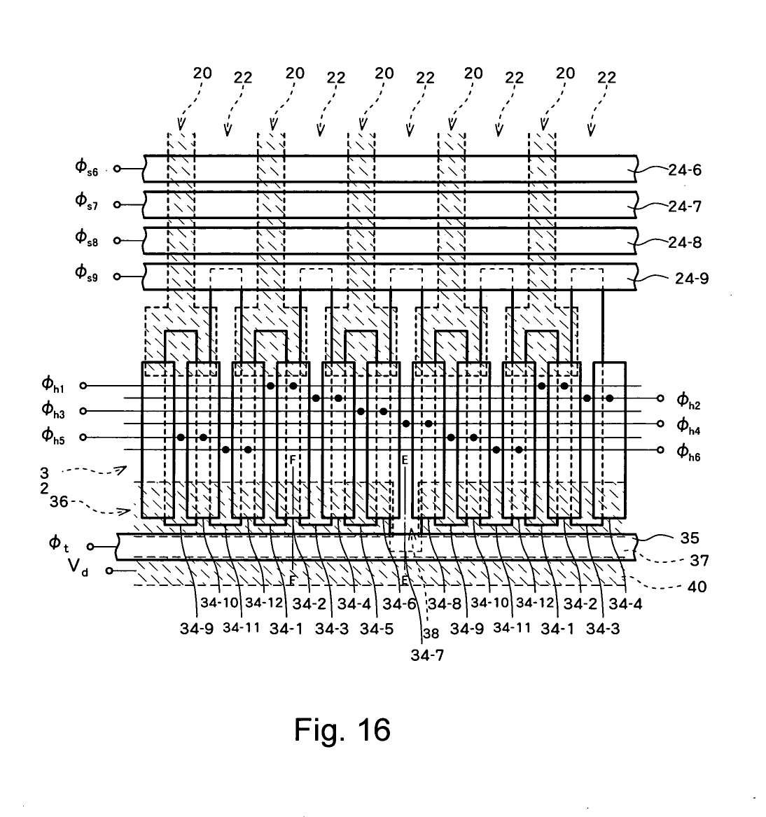

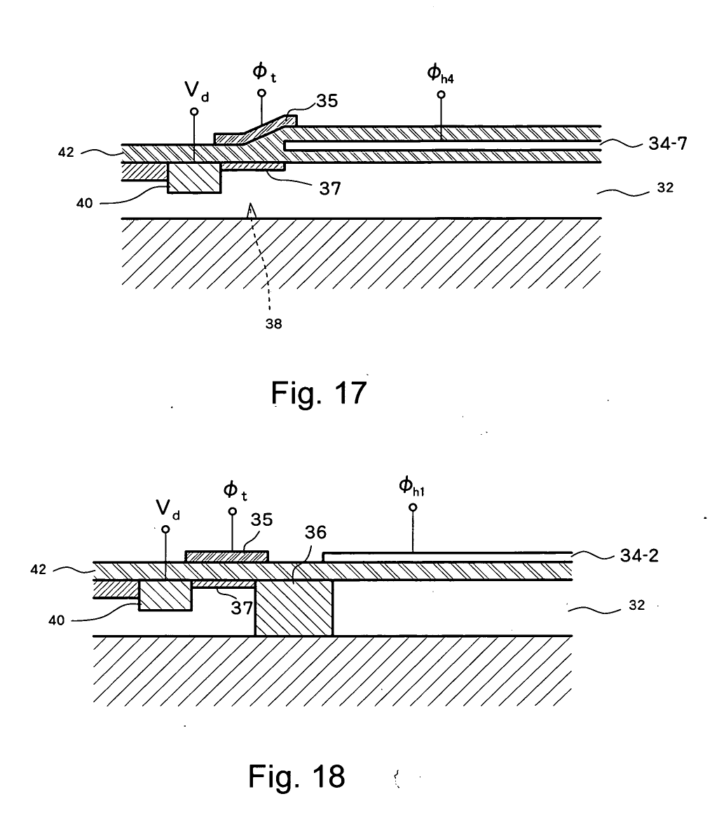

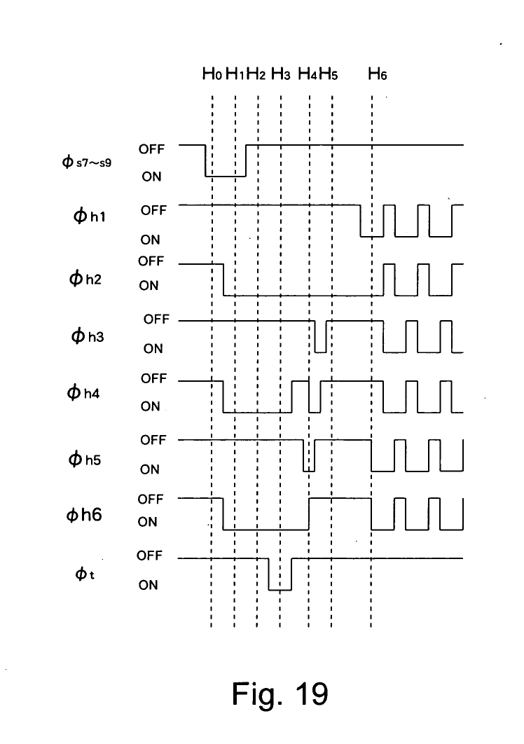

FIG. 16 is a plan view showing the inside of the element in a connecting portion between an output side of the accumulating section 10s and the horizontal transfer section 10h. FIGS. 17 and 18 are sectional views cut along the lines E-E and F-F of FIG. 16, respectively.

The horizontal transfer section 10h includes a horizontal shift register which receives and transfers the information charge output from the vertical shift register of the accumulating section 10s. The horizontal shift register is constituted of: a channel region 32; horizontal transfer electrodes 34-1 to 34-12 and the like.

The channel region 32 is defined by: the isolation region 20 extended from the vertical shift register of the accumulating section 10s; and a horizontal isolation region 36 as a P-type diffusion layer disposed facing the accumulating section 10s, in a direction crossing, at approximately right angles, an extending direction of the vertical shift register. Each channel region 22 of the vertical shift register is connected to the channel region 32 of the horizontal shift register via a gap of the extended isolation region 20.

Moreover, when N-type impurities are added to the substrate surface, a discharge channel region 37 is formed in approximately parallel with the channel region 32 so that the horizontal isolation region 36 is sandwiched between the regions. Furthermore, when N-type impurities are added to the channel region 32 in the vertical direction, a discharge channel 38 is formed so as to connect the channel region 32 to the discharge channel region 37. The discharge channel 38 is formed continuous to the channel region 32. The discharge channel 38 is disposed so that one of three columns of channel regions 22 is extended in the vertical direction every three columns of channel regions 22 juxtaposed continuously.

A discharge region 40 is formed as a high-concentration N-type diffusion area on an output side of the discharge channel 38. The discharge region 40 is disposed to extend along the discharge channel region 37. A discharge voltage Vd is applied to the discharge region 40.

As shown in FIGS. 17 and 18, an insulating film 42 is formed on the isolation region 20, the channel regions 22, 32, the discharge channel region 37, the discharge channel 38 and the discharge region 40. The horizontal transfer electrodes 34-1 to 34-12 are arranged on the insulating film 42 in a state in which the electrodes are electrically insulated from one another. The horizontal transfer electrodes 34-1, 34-3, 34-5, 34-7, 34-9 and 34-11 of odd-numbered columns are disposed in a lower layer, and the horizontal transfer electrodes 34-2, 34-4, 34-6, 34-8, 34-10 and 34-12 of even-numbered columns are disposed in an upper layer.

The horizontal transfer electrodes 34-1, 34-5 and 34-9 are disposed to range between the isolation region 20 and the horizontal isolation region 36 and cover the channel region 32. The horizontal transfer electrodes 34-3 and 34-11 are disposed in the extending direction of the channel region 22 to range from the channel region 22 to the horizontal isolation region 36 and cover the channel region 32. The horizontal transfer electrode 34-7 is disposed in the extending direction of the channel region 22 to cover the channel regions 22, 32, the discharge channel 38 and the discharge channel region 37. The horizontal transfer electrode 34-7 is formed to extend from the horizontal transfer electrodes 34-3, 34-11 in the vertical direction.

The horizontal transfer electrodes 34-2, 34-4, 34-6, 34-8, 34-10 and 34-12 cover gaps among the horizontal transfer electrodes 34-1, 34-3, 34-5, 34-7, 34-9 and 34-11 on the lower layer side, and a part of them are disposed to cover the channel region 32 so that they are superimposed on the transfer electrodes 34-1, 34-3, 34-5, 34-7, 34-9 and 34-11 on the lower layer side via the insulating film.

Furthermore, a discharge electrode 35 is formed on the discharge channel region 37 via the insulating film 42. The discharge electrode is formed along the extending direction of the horizontal isolation region 36 and discharge channel region 37 so as to range from the horizontal transfer electrode 34-7 to the discharge region 40. A discharge clock pulse φt is applied to the discharge electrode 35 in synchronization with vertical clock pulses φₛ₁ to φₛ₉.

Six-phase horizontal clock pulses φₕ₁ to φₕ₆ are applied to the horizontal transfer electrodes 34-1 to 34-12. To be more specific, the horizontal clock pulse φₕ₁ is applied to the horizontal transfer electrodes 34-1, 34-2, the horizontal clock pulse φₕ₂ is applied to the horizontal transfer electrodes 34-3, 34-4, the horizontal clock pulse φₕ₃ is applied to the horizontal transfer electrodes 34-5, 34-6, the horizontal clock pulse φₕ₄ is applied to the horizontal transfer electrodes 34-7, 34-8, the horizontal clock pulse φₕ₅ is applied to the horizontal transfer electrodes 34-9, 34-10, and the horizontal clock pulse φₕ₆ is applied to the horizontal transfer electrodes 34-11, 34-12.

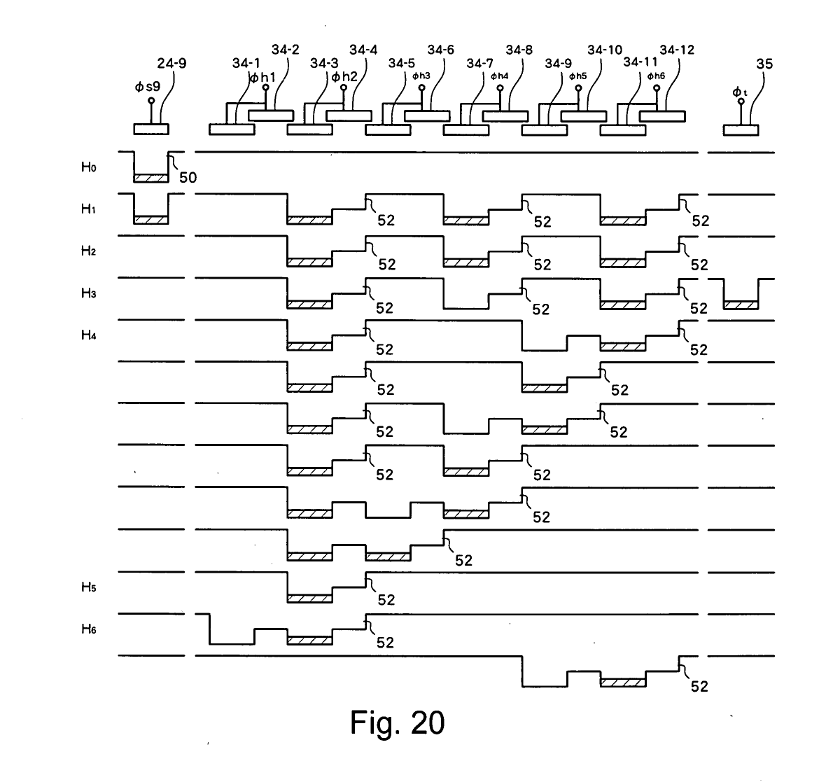

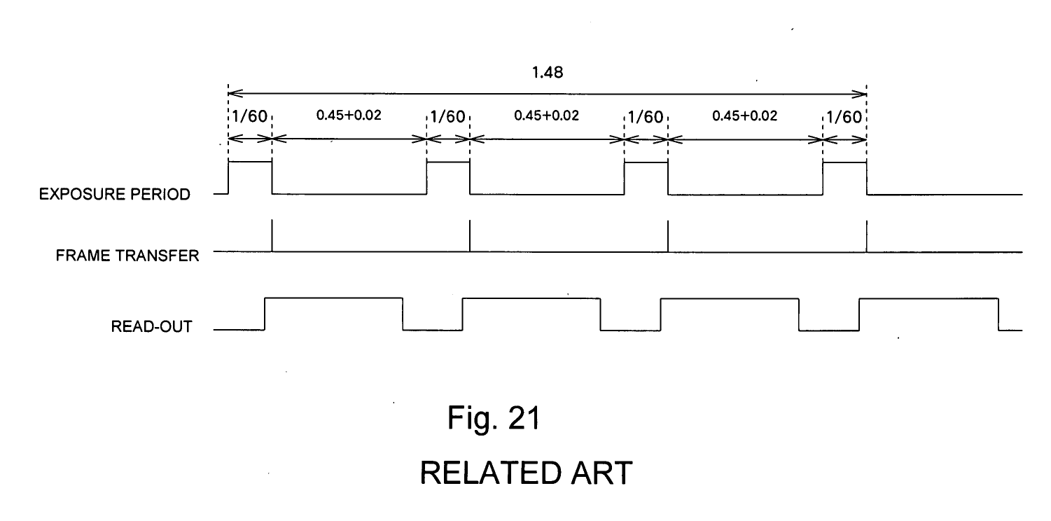

FIG. 19 is a timing chart showing changes of the vertical clock pulses φₛ₇ to φₛ₉ and the horizontal clock pulses φₕ₁ to φₕ₆ during the horizontal transfer. FIG. 20 is a schematic diagram showing a change of a potential and a behavior of transfer of the information charge in the channel region 32 under the horizontal transfer electrodes 34-1 to 34-12.

At a time H₀, the vertical clock pulses φₛ₇ to φₛ₉ which have been applied to the transfer electrodes 24-7 to 24-9 positioned closest to the output side of the vertical shift register of the accumulating section 10s are turned on, and a potential well 50 is formed under the transfer electrodes 24-7 to 24-9. At this time, all of the horizontal clock pulses φₕ₁ to φₕ₆ are turned off, and no potential well is formed in the channel region 32. The information charges added up and synthesized in the vertical direction are accumulated in the potential well 50.

At a time H1, the horizontal clock pulses φₕ₂, φₕ₄ and φₕ₆ are turned on, and a potential well 52 is formed in the channel region 32 under the horizontal transfer electrodes 34-3, 34-7 and 34-11. Subsequently, at a time H₂, the vertical clock pulses φₛ₇ to φₛ₉ are turned off. Accordingly, the information charges accumulated in the potential well 50 under the transfer electrodes 24-7 to 24-9 are output to the potential well 52 under the horizontal transfer electrodes 34-3, 34-7 and 34-11.

At a time H₃, the discharge clock pulse φt applied to the discharge electrode 35 is turned on. Accordingly, the information charges accumulated in the potential well 52 under the horizontal transfer electrode 34-7 are discharged to the discharge region 40 via the discharge channels 38 and 37.

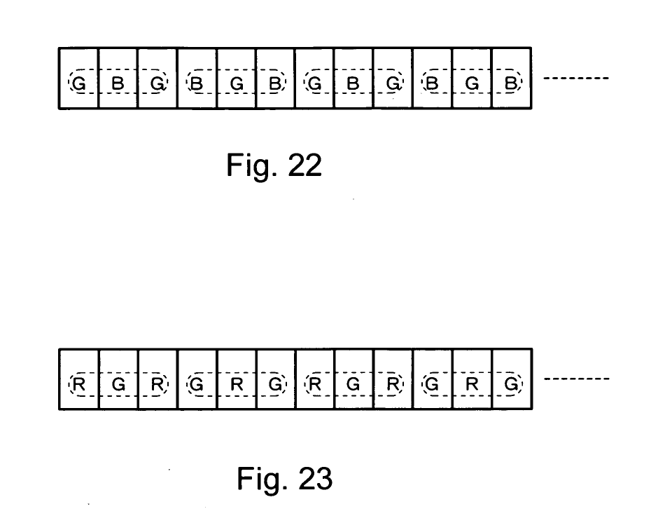

For a time of H₄ to H₅, the information charges existing in the potential well 52 under the horizontal transfer electrodes 34-3, 34-11 are added up and synthesized in the horizontal direction. In the solid image pickup element 10, as shown in FIG. 5, the row in which the information charges corresponding to the wavelength regions of the green (G) and blue (B) are alternately accumulated in the horizontal direction is disposed in the vertical direction alternately with a row in which the information charges corresponding to the wavelength regions of the red (R) and green (G) are alternately accumulated. That is, as shown in FIG. 22, in the row in which the information charges corresponding to the wavelength regions of the green (G) and blue (B) are alternately accumulated, a set of G, B and G and a set of B, G and B are repeatedly arranged from the left. In the set of G, B and G, the information charge generated in accordance with the green wavelength component is added to the pixels corresponding to G of opposite ends of the set and synthesized. In the set of B, G and B, the information charge generated in accordance with the blue wavelength component is added to the pixels corresponding to B of opposite ends of the set and synthesized. As shown in FIG. 23, in a row in which the information charges corresponding to the wavelength regions of the red (R) and green (G) are alternately accumulated, a set of R, G and R and a set of G, R and G are repeatedly arranged from the left. In the set of R, G and R, the information charge generated in accordance with the red wavelength component is added to the pixels corresponding to R of opposite ends of the set and synthesized. In the set of G, R and G, the information charge generated in accordance with the green wavelength component is added to the pixels corresponding to G of opposite ends of the set and synthesized.

At and after a time H₆, the information charges added up and synthesized in the horizontal direction are transferred along the channel region 32 in the horizontal direction. The horizontally transferred information charges are output to the output section 10d, and output as CCD output signals in accordance with an amount of the information charges. At this time, four continuously arranged horizontal transfer electrodes 34 are regarded as a set, and in-phase horizontal clock pulses are applied to the set of horizontal transfer electrodes to thereby horizontally transfer the information charges. For example, in the present embodiment, the horizontal transfer electrodes 34-1 to 34-4, 34-5 to 34-8 and 34-9 to 34-12 are regarded as sets, respectively, the in-phase horizontal clock pulses are applied to the horizontal transfer electrodes 34 included in each set, and different-phase horizontal clock pulses are applied to different sets to thereby horizontally transfer the information charges.

As described above, when the information charges are added up and synthesized in the horizontal direction even during the horizontal transfer, the image signals can be compressed and transferred in the horizontal direction. Accordingly, not only the transfer time of the information charge in the vertical direction but also the transfer time of the information charge in the horizontal direction can be shortened to about ⅓ of the conventional time.

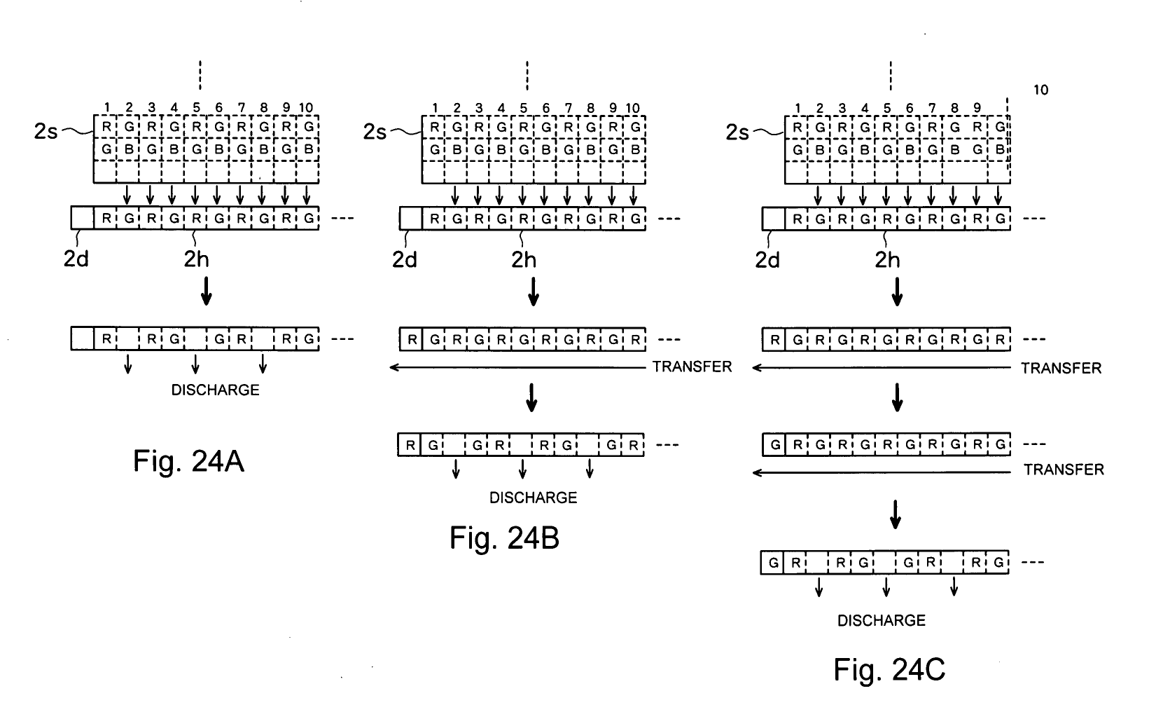

Moreover, it is preferable that the position of the pixel from which the information charge is to be discharged is changed for each frame in the horizontal direction in the same manner as in the vertical direction. That is, as shown in FIGS. 24A to 24C, it is preferable that the column whose information charge is extracted to the discharge region 40 is changed for each image frame.

In the first image frame, as shown in FIGS. 20 and 24A, the information charges accumulated in the potential well 50 under the transfer electrodes 24-7 to 24-9 are output to the potential well 52 under the horizontal transfer electrodes 34-3, 34-7 and 34-11. Thereafter, the discharge clock pulse φt applied to the discharge electrode 35 is turned on. Accordingly, the information charge corresponding to the 3k+2-th column (k is 0 or natural number) is discharged. Thereafter, the information charges of the 3k+1-th and 3k+3-th columns are added up, synthesized, and output.

In the second image frame, as shown in FIGS. 20 and 24B, the information charges accumulated in the potential well 50 under the transfer electrodes 24-7 to 24-9 are output to the potential well 52 under the horizontal transfer electrodes 34-3, 34-7 and 34-11. After the information charge is horizontally transferred by as one column toward the output section 10d, the discharge clock pulse φt applied to the discharge electrode 35 is turned on. Accordingly, the information charge corresponding to the 3k+3-th column (k is 0 or natural number) is discharged. Thereafter, the information charges of the 3k+2-th and 3k+4-th columns are added up, synthesized, and output.

In the third image frame, as shown in FIGS. 20 and 24C, the information charges accumulated in the potential well 50 under the transfer electrodes 24-7 to 24-9 are output to the potential well 52 under the horizontal transfer electrodes 34-3, 34-7 and 34-11. After the information charges are horizontally transferred by two columns toward the output section 10d, the discharge clock pulse φt applied to the discharge electrode 35 is turned on. Accordingly, the information charge corresponding to the 3k+4-th column (k is 0 or natural number) is discharged. Thereafter, the information charges of the 3k+3-th and 3k+5-th columns are added up, synthesized, and output.

It is to be noted that in a case where the vibration reduction processing is performed using the image signal compressed in the horizontal direction, horizontal interpolation processing may be performed on the image signal compressed in the horizontal direction in the same manner as in the vertical interpolation processing of the image signal compressed in the vertical direction. The horizontal interpolation processing is performed in the image signal processing section 14.

First, the image frame is filtered in the vertical direction based on the output value of the image frame, and the wavelength components of the red (R), green (G) and blue (B) of each pixel are calculated. The pixel included in the compressed image frame is successively selected as the noted pixel constituting the calculation object, the filtering coefficient is multiplied by the pixel existing in the predetermined region from the noted pixel in the vertical direction (column direction), and the average value of multiplication results is calculated to thereby calculate the wavelength components of the noted pixel. The filtering is performed with respect to all of the compressed image frames among a plurality of image frames for use in the vibration reduction processing. As the filtering, the method described above may be used.

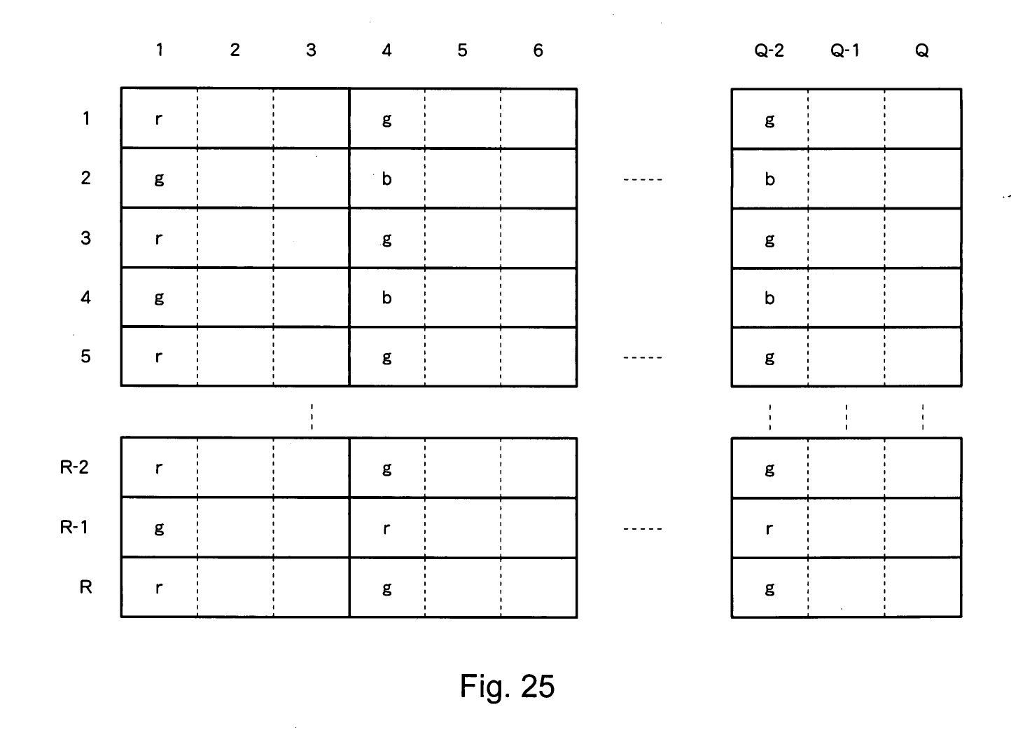

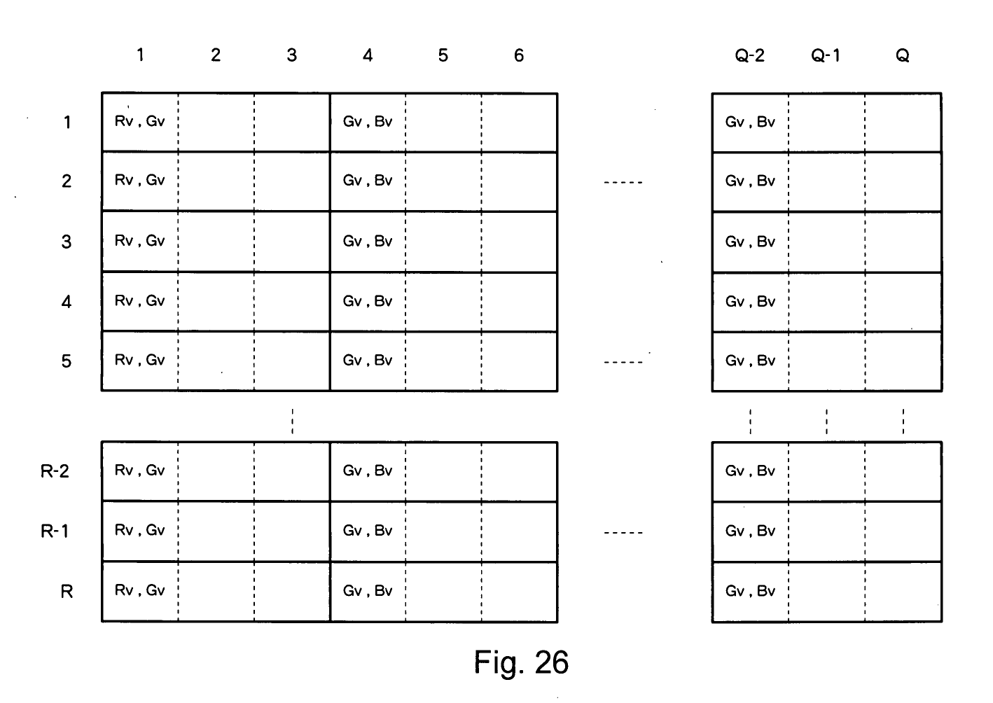

During the filtering in the vertical direction with respect to a row (e.g., first row) in which wavelength components r, g of the red (R) and green (G) are alternately output as shown in FIG. 25, wavelength components Rv, Gv of the red (R) and green (G) of each pixel are calculated as shown in FIG. 26. As to a row (e.g., second row) in which wavelength components g, b of the green (G) and blue (B) are alternately output as shown in FIG. 25, wavelength components Gv, By of the green (G) and blue (B) of each pixel are calculated as shown in FIG. 26.

Next, the image frame is filtered in the horizontal direction based on the output value of each pixel of the compressed image frame, and the wavelength components of the red (R), green (G) and blue (B) of each pixel are calculated. The pixel included in the compressed image frame is successively selected as the noted pixel constituting the calculation object, the filtering coefficient is multiplied by the pixel existing in the predetermined region from the noted pixel in the horizontal direction (row direction), and the average value of the multiplication results is calculated to thereby calculate the wavelength components of the noted pixel. The filtering is performed with respect to all of the compressed image frames among the plurality of image frames for use in the vibration reduction processing.

All of the wavelength components of each noted pixel are filtered. That is, for the pixel in which the red (R) wavelength component Rv and the green (G) wavelength component Gv have already been calculated, the red (R) and green (G) wavelength components are filtered in the horizontal direction to average the random noise, and the blue (B) wavelength component which has not yet been calculated is calculated. Similarly, for the pixel in which the green (G) wavelength component Gv and the blue (B) wavelength component By have already been calculated, the green (G) and blue (B) wavelength components are filtered in the horizontal direction to average the random noise, and the red (R) wavelength component which has not yet been calculated is calculated.

In a case where seven pixels arranged continuously along the horizontal direction are filtered as processing objects, assuming that a pixel (r, q) of an r-th row and a q-th column is the noted pixel, a wavelength component R_{r, q} of the red (R) with respect to the pixel (r, q) can be calculated by R_{r, q}=(κ×Rv_{r, q-3}+λ×Rv_{r, q}+μ×Rv_{r, q+3})/(κ+λ+μ)/2. Here, it is assumed that (κ, λ, μ) is a filtering coefficient, κ=μm, and Rvᵢⱼ is a wavelength component of the red (R) of the pixel (i, j) filtered in the horizontal direction. Similarly, a wavelength component G_{r, q} of the green (G) with respect to the pixel (r, q) can be calculated by G_{r, q}=(κ×Gv_{r, q-3}+λ×Gv_{r, q}+μ×Gv_{r, q+3})/(κ+λ+μ), wherein Gvᵢⱼ is a wavelength component of the green (G) of the pixel (i, j) filtered in the horizontal direction. A wavelength component B_{r, q} of the blue (B) with respect to the pixel (r, q) can be calculated by B_{r, q}=(κ×Bv_{r, q-3}+λ×Bv_{r, q}+μ×Bv_{r, q+3})/(κ+λ+μ)/2, wherein Bvᵢⱼ is a wavelength component of the blue (B) of the pixel (i, j) filtered in the horizontal direction.

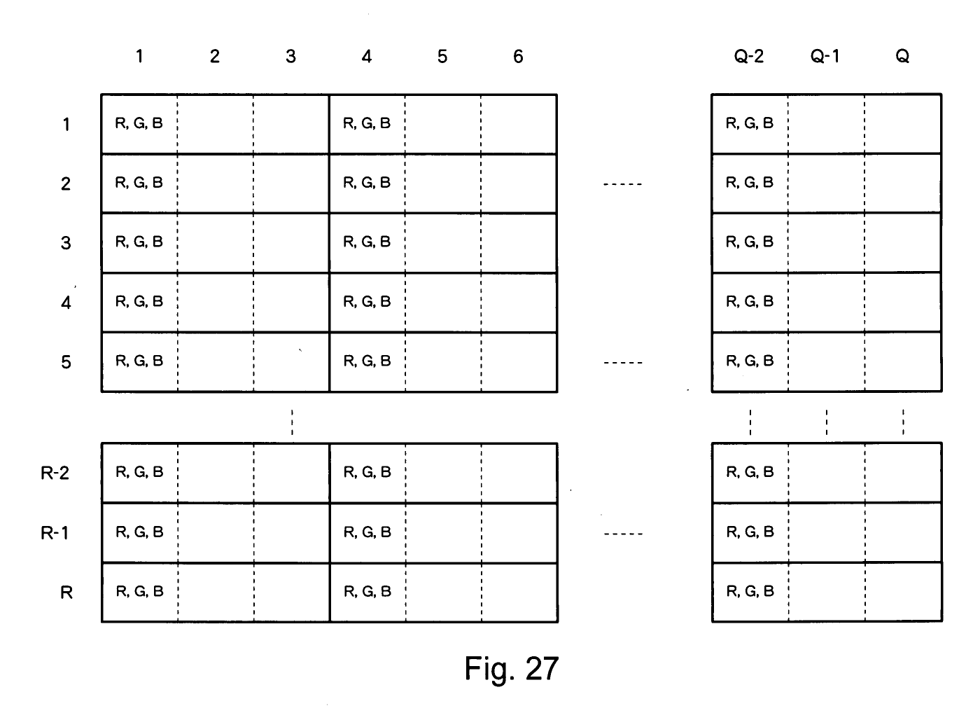

When the filtering is performed in the horizontal direction, as shown in FIG. 27, the wavelength components R, G and B of the red (R), green (G) and blue (B) with respect to a plurality of pixel sets are obtained, respectively, and the random noise can be averaged.

Moreover, the interpolation may be further performed during the compression in the horizontal direction as described above. After executing the filtering, all of the pixels that do not have any wavelength component (pixel value) are subjected to the interpolation processing. Accordingly, the image frame of all the pixels (full image) can be obtained from the compressed image frame.

It is to be noted that in a case where the transfer electrode to be turned on during the image pickup is changed with each frame as shown in FIGS. 11A to C, the addition and synthesis of the information charges in the vertical direction as shown in FIGS. 11A to C may be combined with those of the information charges in the horizontal direction as shown in FIGS. 24A to C, respectively, to execute the compression processing in order.

For example, in a case where the first image frame is picked up, as shown in FIG. 11A, only pixels corresponding to the transfer electrodes 24-4 to 24-6 are turned off, and no information charge is accumulated by the electronic shutter operation. The information charges accumulated in the transfer electrodes 24-1 to 24-3 and those accumulated in the transfer electrodes 24-7 to 24-9 are added up, synthesized, and vertically transferred. As shown in FIG. 24A, the information charge corresponding to the 3k+2-th column (k is 0 or natural number) is discharged. Moreover, the information charges of the 3k+1-th and 3k+3-th columns are added up, synthesized, and output. In a case where the second image frame is picked up, as shown in FIG. 11B, only pixels corresponding to the transfer electrodes 24-1 to 24-3 are turned off, and information charge is accumulated by the electronic shutter operation. The information charges accumulated in the adjacent sets of the transfer electrodes 24-7 to 24-9 and the transfer electrodes 24-4 to 24-6 are added up, synthesized, and vertically transferred. As shown in FIG. 24A, the information charge corresponding to the 3k+2-th column (k is 0 or natural number) is discharged, and the information charges of the 3k+1-th column and the 3k+3-th column are added up, synthesized, and output. In a case where the third image frame is picked up, as shown in FIG. 11C, only pixels corresponding to the transfer electrodes 24-7 to 24-9 are turned off, and no information charge is accumulated by the electronic shutter operation. The information charges accumulated in the adjacent sets of the transfer electrodes 24-4 to 24-6 and the transfer electrodes 24-1 to 24-3 are added up, synthesized, and vertically transferred. As shown in FIG. 24A, the information charge corresponding to the 3k+2-th column (k is 0 or natural number) is discharged. Moreover, the information charges of the 3k+1-th and 3k+3-th columns are added up, synthesized, and output.

In a case where the fourth image frame is picked up, as shown in FIG. 11A, only pixels corresponding to the transfer electrodes 24-4 to 24-6 are turned off, and no information charge is accumulated by the electronic shutter operation. The information charges accumulated in the transfer electrodes 24-1 to 24-3 and those accumulated in the transfer electrodes 24-7 to 24-9 are added up, synthesized, and vertically transferred. As shown in FIG. 24B, the information charge corresponding to the 3k+3-th column (k is 0 or natural number) is discharged. Moreover, the information charges of the 3k+2-th and 3k+4-th columns are added up, synthesized, and output. In a case where the fifth image frame is picked up, as shown in FIG. 11B, only pixels corresponding to the transfer electrodes 24-1 to 24-3 are turned off, no information charge is accumulated by the electronic shutter operation. The information charges accumulated in the adjacent sets of the transfer electrodes 24-7 to 24-9 and the transfer electrodes 24-4 to 24-6 are added up, synthesized, and vertically transferred. As shown in FIG. 24B, the information charge corresponding to the 3k+3-th column (k is 0 or natural number) is discharged, and the information charges of the 3k+2-th and the 3k+4-th column are added up, synthesized, and output. In a case where the sixth image frame is picked up, as shown in FIG. 11C, only pixels corresponding to the transfer electrodes 24-7 to 24-9 are turned off, and no information charge is accumulated by the electronic shutter operation. The information charges accumulated in the adjacent sets of the transfer electrodes 24-4 to 24-6 and the transfer electrodes 24-1 to 24-3 are added up, synthesized, and vertically transferred. As shown in FIG. 24B, the information charge corresponding to the 3k+3-th column (k is 0 or natural number) is discharged. Moreover, the information charges of the 3k+2-th and 3k+4-th columns are added up, synthesized, and output.

In a case where the seventh image frame is picked up, as shown in FIG. 11A, only pixels corresponding to the transfer electrodes 24-4 to 24-6 are turned off, and no information charge is accumulated by the electronic shutter operation. The information charges accumulated in the transfer electrodes 24-1 to 24-3 and those accumulated in the transfer electrodes 24-7 to 24-9 are added up, synthesized, and vertically transferred. As shown in FIG. 24C, the information charge corresponding to the 3k+4-th column (k is 0 or natural number) is discharged. Moreover, the information charges of the 3k+3-th and 3k+5-th columns are added up, synthesized, and output. In a case where the eighth image frame is picked up, as shown in FIG. 11B, only pixels corresponding to the transfer electrodes 24-1 to 24-3 are turned off, and no information charge is accumulated by the electronic shutter operation. The information charges accumulated in the adjacent sets of the transfer electrodes 24-7 to 24-9 and the transfer electrodes 24-4 to 24-6 are added up, synthesized, and vertically transferred. As shown in FIG. 24C, the information charge corresponding to the 3k+4-th column (k is 0 or natural number) is discharged, and the information charges of the 3k+3-th and the 3k+5-th column are added up, synthesized, and output. In a case where the ninth image frame is picked up, as shown in FIG. 1C, only pixels corresponding to the transfer electrodes 24-7 to 24-9 are turned off, and no information charge is accumulated by the electronic shutter operation. The information charges accumulated in the adjacent sets of the transfer electrodes 24-4 to 24-6 and the transfer electrodes 24-1 to 24-3 are added up, synthesized, and vertically transferred. As shown in FIG. 24C, the information charge corresponding to the 3k+4-th column (k is 0 or natural number) is discharged. Moreover, the information charges of the 3k+3-th and 3k+5-th columns are added up, synthesized, and output.

When the image is compressed and transferred in the horizontal direction as described above, the transfer time can be shortened, and the image frames obtained per unit time can be increased. In consequence, precision of the vibration reduction processing can be improved. Since the information charges are added up and synthesized even in the horizontal direction, influences of random noise can be reduced.

Furthermore, during the addition and synthesis of the information charges, the pixels are displaced every image frame even with respect to the horizontal direction to add up and synthesize the information charges, as a result of which the filtering or the interpolation processing can be averaged spatially.

<Modification of Horizontal Compression Transfer of Image Signal>

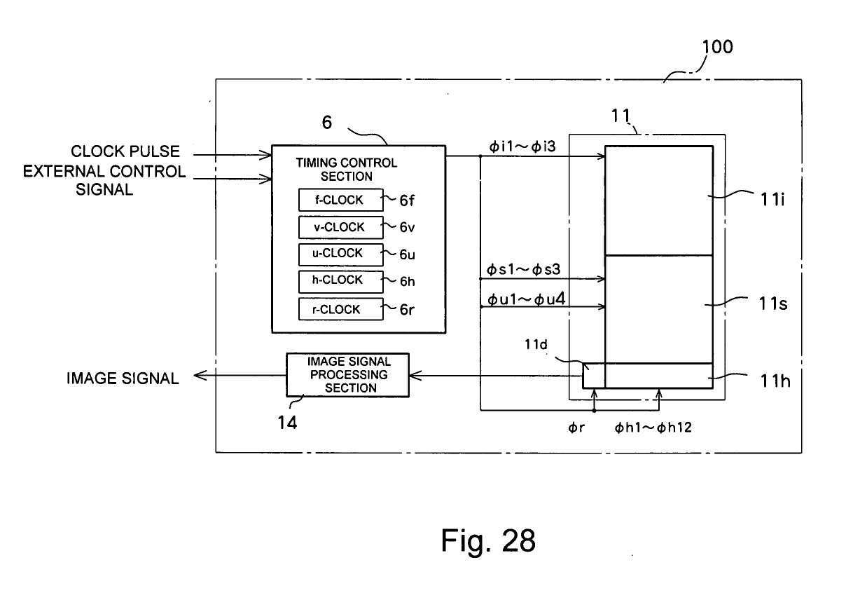

In a modification of the present embodiment, as shown in FIG. 28, a solid image pickup device includes a CCD solid image pickup element 11 and a driving circuit 6. The CCD solid image pickup element 11 of a frame transfer type includes an image pickup section 11i, an accumulating section 11s, a horizontal transfer section 11h, and an output section 11d in the same manner as in the CCD solid image pickup element 10. The timing control unit 6 includes a frame clock pulse generating section 6f, a vertical clock pulse generating section 6v, an auxiliary clock pulse generating section 6u, a horizontal clock pulse generating section 6h, and a reset clock pulse generating section 6r. The CCD solid image pickup element 11 is controlled by various clock pulses received from the driving circuit 6.

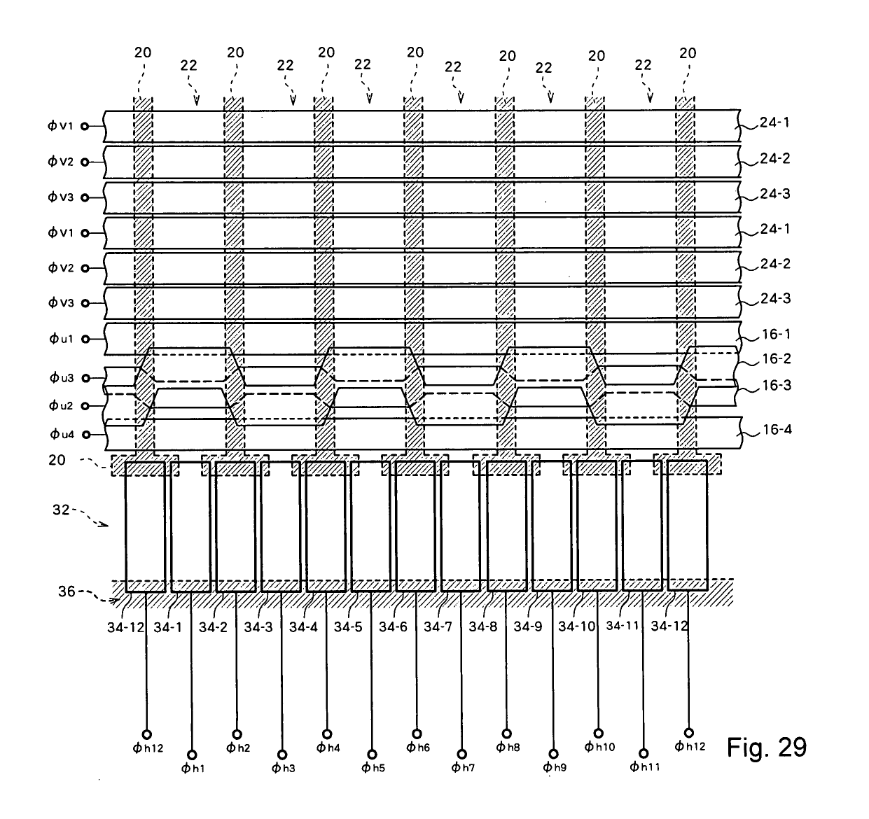

FIG. 29 is a plan view showing an inner structure of a connecting portion between the accumulating section 11s and the horizontal transfer section 11h of the CCD solid image pickup element 11 in the modification of the present embodiment. It is to be noted that the whole constitution of the CCD solid image pickup element 11 is similar to that of the CCD solid image pickup element 10.

The horizontal transfer section 11h includes a horizontal shift register which receives and transmits information charge output from a vertical shift register of the accumulating section 11s. The horizontal shift register is constituted of a channel region 32 and a horizontal transfer electrode 34. The channel region 32 is defined in a direction crossing an extending direction of the vertical shift register at right angles by isolation regions 20 extended from the vertical shift register of the accumulating section 11s and a horizontal isolation region 36 as a P-type diffusion layer disposed facing the accumulating section 11s. Channel regions 22 of the vertical shift register are connected to the channel region 32 of the horizontal shift register via gaps of the extended isolation regions 20.

Auxiliary transfer electrodes 16-1 to 16-4 are formed in a connecting region between the accumulating section 11s and the horizontal transfer section 11h. The auxiliary transfer electrodes 16-1 to 16-4 are formed as multilayered electrodes electrically insulated from one another via the insulating film. The auxiliary transfer electrode 16-1 is disposed at a predetermined interval in parallel with the transfer electrode 24 on a side which is farthest from the horizontal shift register. The auxiliary transfer electrode 16-4 is disposed in parallel with the transfer electrode 24 on a side closest to the horizontal shift register. The auxiliary transfer electrodes 16-2 and 16-3 are arranged in a region between the auxiliary transfer electrodes 16-1 and 16-4 so that a part of the auxiliary transfer electrode 16-2, 16-3 is superimposed on the auxiliary transfer electrode 16-1, 16-4 via the insulating film. The auxiliary transfer electrode 16-3 is disposed in parallel with the transfer electrode 24 in a zigzag manner so that the auxiliary transfer electrode comes close to the horizontal shift register in an odd-numbered column, and is separated from the horizontal shift register in an even-numbered column. The auxiliary transfer electrode 16-2 is disposed on the auxiliary transfer electrode 16-3 via the insulating film in a zigzag manner so that the auxiliary transfer electrode is separated from the horizontal shift register in the odd-numbered column, and comes close to the horizontal shift register in the even-numbered column. Here, the upper-layer auxiliary transfer electrode 16-2 is disposed so that the electrode is superimposed on the lower-layer auxiliary transfer electrode 16-3 in each channel region 22 of the odd-numbered column. Accordingly, an influence of a voltage applied to the upper-layer auxiliary transfer electrode 16-2 acts on the channel region 22 of even-numbered column. That is, each of the auxiliary transfer electrodes 16-1 to 16-4 forms one auxiliary bit in an output end of the channel region 22 of the even-numbered column. Since four-phase auxiliary clock pulses φᵤ₁ to φᵤ₄ are applied to the auxiliary transfer electrodes 16-1 to 16-4, respectively, the information charges for one pixel can be temporarily accumulated in the channel region 22 of the even-numbered column while the accumulating section 11s transfers the information charge to the horizontal transfer section 11h. It is to be noted that the auxiliary transfer electrode 16 is not limited to the electrode controlled by the four-phase pulses as long as the information charge of the even-numbered column can be vertically transferred to the odd-numbered column with a delay as much as one pixel.

The horizontal transfer electrode 34 is formed on the channel region 32 extended in a direction crossing the vertical shift register at right angles. Two horizontal transfer electrodes 34 are disposed every vertical shift register in order from the vertical shift register of the odd-numbered column, which is adjacent to the output section 11d of the horizontal shift register. In the present embodiment, 12 horizontal transfer electrodes 34-1 to 34-12 are regarded as a set, and are arranged in order along the transfer direction of the horizontal shift register. Here, the horizontal transfer electrodes 34-1, 34-3, 34-5, 34-7, 34-9 and 34-11 extended from the channel regions 22 of the vertical shift register are arranged in the channel region 32 via the insulating film so as to range from the channel regions 22 to the horizontal isolation region 36. The horizontal transfer electrodes 34-2, 34-4, 34-6, 34-8, 34-10 and 34-12 are arranged in the channel region 32 via the insulating film so as to range from the isolation regions 20 to the horizontal isolation region 36. In the present embodiment, horizontal clock pulses φₕ₁ to φₕ₁₂ which are controllable independently of one another are applied to 12 horizontal transfer electrodes 34-1 to 34-12 corresponding to six vertical shift registers arranged continuously along the horizontal transfer direction to thereby control the electrodes.

Next, there will be described the constituting sections of the driving circuit 6. The frame clock pulse generating section 6f generates three-phase frame clock pulses φᵢ in response to a frame shift timing signal FT supplied from the outside to supply the pulses to the transfer electrodes of the vertical shift registers of the image pickup section 11i. In response to this frame clock pulse φᵢ, the information charge accumulated in each light receiving pixel of the image pickup section 11i is transferred to the accumulating section 11s every vertical scanning period. The vertical clock pulse generating section 6v generates three-phase vertical clock pulses φₛ in response to a vertical synchronous signal VT and a horizontal synchronous signal HT to supply the pulse to the transfer electrode of the vertical shift register of the accumulating section 11s. In the present embodiment, in the image pickup section 11i and the accumulating section 11s, three continuously arranged transfer electrodes 24-1 to 24-3 correspond to one horizontal line. Therefore, in a case where the three-phase clock pulses which change as the frame clock pulse φᵢ and the vertical clock pulse φₛ in different phases are applied to the transfer electrodes 24-1 to 24-3, respectively, the information charge can be vertically transferred every horizontal line. It is to be noted that in a case where nine transfer electrodes 24-1 to 24-9 arranged continuously in the transfer direction are regarded as one set, and the frame clock pulse φᵢ and the vertical clock pulse φₛ which are controllable independently of each other are supplied to the sets of the transfer electrodes 24-1 to 24-9, respectively, as in the present embodiment, the information charges corresponding to the same color can be added up and transferred as the compressed signal in the vertical direction.

The horizontal clock pulse generating section 6h generates a horizontal clock pulse φₕ in response to the horizontal synchronous signal HT to supply the pulse to the horizontal transfer electrode 34 of the horizontal transfer section 11h. Here, it is assumed that in a case where the information charges for n pixels are added up, synthesized, and transferred in the horizontal shift register, the horizontal clock pulse generating section 6h can generate the horizontal clock pulses φₕ which are controllable independently of one another with respect to the horizontal transfer electrode 34 connected to 2n continuously arranged vertical shift registers. In the present embodiment, since the information charges for three pixels are added up and synthesized, it is possible to generate 12-phase horizontal clock pulses φₕ controlled independently of one another with respect to 12 horizontal transfer electrodes 34-1 to 34-12 connected to six vertical shift registers. The auxiliary clock pulse generating section 6u generates four-phase auxiliary clock pulses φᵤ having a period which is ½ of a one-bit transfer period of the vertical clock pulse φₛ in response to the horizontal synchronous signal HT, and supplies the pulses to the auxiliary transfer electrodes 16. In response to this auxiliary clock pulse φᵤ, the information charges transferred to the vertical shift register of the accumulating section 11s are transferred to the horizontal transfer section 11h alternately in the odd-numbered column and the even-numbered column. Controls of the vertical clock pulse φₛ, the horizontal clock pulse φₕ and the auxiliary clock pulse φᵤ will be described later.

The reset clock pulse generating section 6r generates a reset clock pulse φᵣ in synchronization with the horizontal clock pulse φₕ generated in the horizontal clock pulse generating section 6h to supply the pulse to the output section 11d. This reset clock pulse φᵣ is supplied to a gate of a switching element which connects a capacitance of the output section 11d to a deep substrate portion for use in discharging the information charge accumulated in the capacitance of the output section 11d to the substrate.

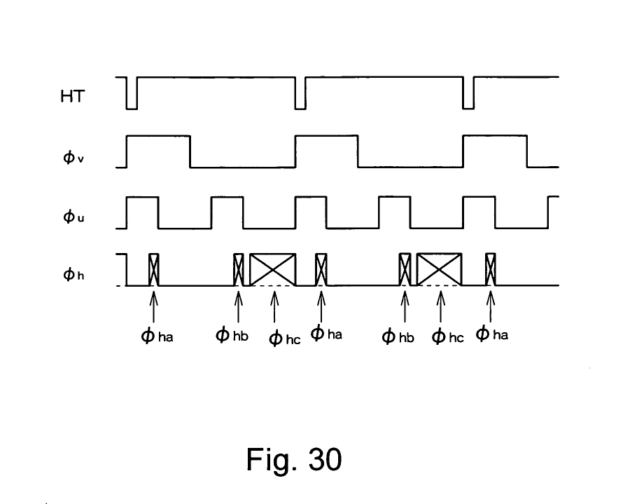

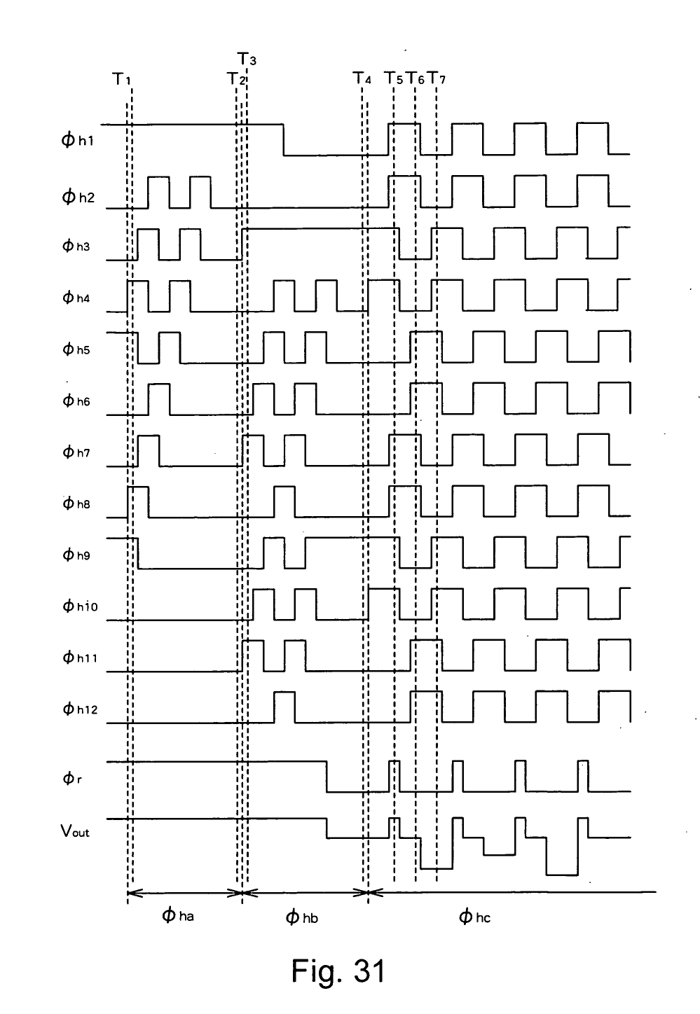

FIGS. 30 and 31 show timing charges of the clock pulses in a case where resolution of an image is lowered and the image is transferred at a high speed by use of the solid image pickup device of the present embodiment. FIG. 30 shows a relationship among the horizontal synchronous signal HT, the vertical clock pulse φₛ, the auxiliary clock pulse φᵤ and the horizontal clock pulse φₕ. FIG. 31 shows behaviors of changes of the horizontal clock pulse φₕ, the reset clock pulse φᵣ and an output signal Vₒᵤₜ during horizontal transfer. In FIG. 31, an upper part of the ordinate indicates a positive voltage, and a lower part thereof indicates a negative voltage. It is to be noted that the vertical clock pulse φₛ has three phases, and the auxiliary clock pulse φᵤ has four phases, but FIG. 30 shows representative clocks only.

The vertical clock pulses φₛ are applied to the transfer electrodes 24-1 to 24-3 in a period corresponding to the horizontal synchronous signal HT. The vertical clock pulse φₛ is constituted of three-phase pulses φₛ₁ to φₛ₃ which change with different phases, respectively. Accordingly, the information charge is transferred along the channel region 22 of the vertical shift register every horizontal line in one horizontal transfer period. The auxiliary clock pulses φᵤ are applied to the auxiliary transfer electrodes 16-1 to 16-4 in a period which is ½ of that of the horizontal synchronous signal HT. Since the auxiliary transfer electrodes 16-1 to 16-4 function effectively in only output ends of the vertical shift registers of the even-numbered columns as described above, a potential state is controlled so that the pulses are transferred every two pixels in one horizontal transfer period in each channel region 22 of the vertical shift register of the even-numbered column. At this time, only information charges for one pixel are transferred from the transfer electrodes 24-1 to 24-3 to the auxiliary transfer electrodes 16-1 to 16-4 in response to the vertical clock pulse φₛ. Therefore, the information charges for one pixel are transferred to the horizontal shift register at a timing deviating as much as a period which is ½ of a vertical transfer period in the odd-numbered column vertical shift register and the even-numbered column vertical shift register.

The horizontal clock pulse φₕ is generated in response to the vertical clock pulse φₛ and the auxiliary clock pulse φᵤ, and is applied to the horizontal transfer electrodes 34-1 to 34-12 in a period which is shorter than the horizontal transfer period. In the present embodiment, the horizontal clock pulse φₕ is constituted of a combination of charge synthesis clock pulses φₕₐ, φ_{hb} and a charge transfer clock pulse φ_{hc}. Accordingly, the information charges of a plurality of pixels corresponding to the same wavelength region (the same color) included in one horizontal line are added up and synthesized in the horizontal shift register, and transferred toward the output section 11d.

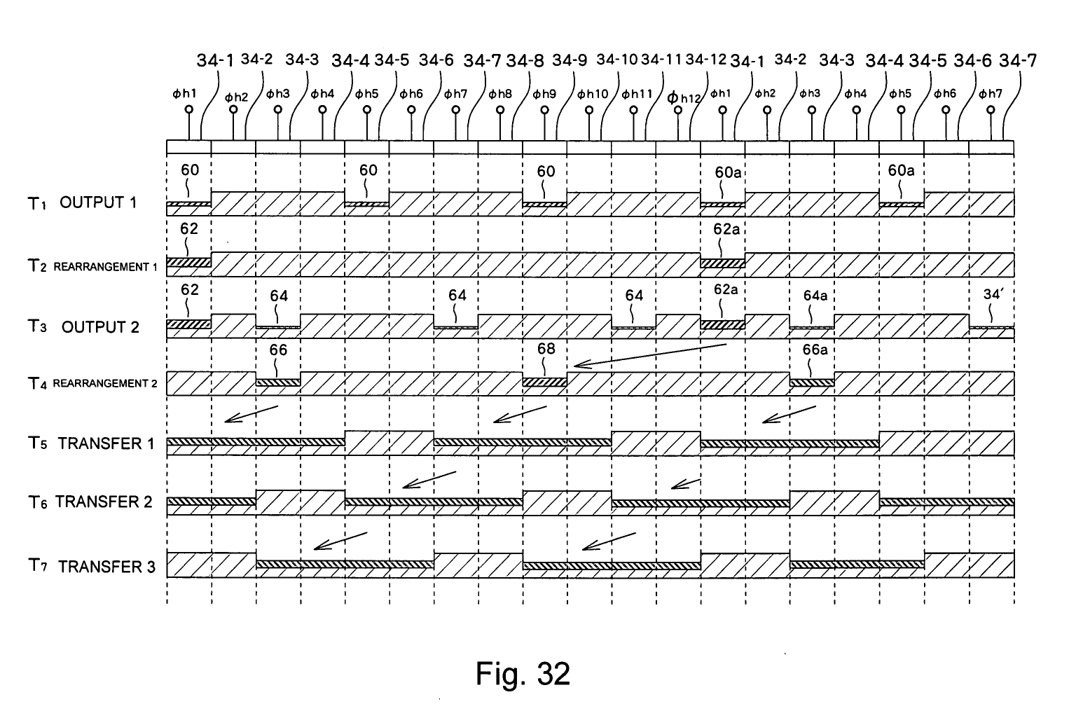

FIG. 32 shows a state of the potential well formed in the horizontal shift register at a time when the horizontal clock pulse φₕ is applied. In FIG. 32, the abscissa indicates positions corresponding to the respective horizontal transfer electrodes 34-1 to 34-12, an upper part of the ordinate indicates a negative potential, and a lower part thereof indicates a positive potential.

In the present embodiment, the horizontal clock pulses φₕ₁ to φₕ₁₂ to be applied to the horizontal transfer electrodes 34-1 to 34-12 are independently controlled to thereby add up and synthesize the information charges corresponding to the same color for three pixels only. At a time T1, the horizontal clock pulses φₕ₁, φₕ₅ and φₕ₉ to be applied to the horizontal transfer electrodes 34-1, 34-5 and 34-9 are set to high levels. The information charges transferred from the odd-numbered columns of the vertical shift registers are accumulated in a potential well 60 (60a) formed under the horizontal transfer electrodes 34-1, 34-5 and 34-9. For example, the information charge corresponding to the wavelength region of the red (R) of each odd-numbered column is transferred to the horizontal shift register. Thereafter, the horizontal clock pulses φₕ₁ to φₕ₉ are successively changed until a time T₂. Accordingly, the information charges accumulated in the potential well 60 (60a) formed under the horizontal transfer electrodes 34-5 and 34-9 are rearranged in a potential well 62 (62a) formed under the horizontal transfer electrode 34-1. Subsequently, at a time T₃, the horizontal clock pulses φₕ₃, φₕ₇ and φₕ₁₁ to be applied to the horizontal transfer electrodes 34-3, 34-7 and 34-11 are set to high levels. The information charges transferred from the even-numbered columns of the vertical shift registers are accumulated in a potential well 64 formed under the horizontal transfer electrodes 34-3, 34-7 and 34-11, respectively. Here, the information charge corresponding to the wavelength region of the green (G), which has been disposed on the same horizontal line as that of the information charge corresponding to the wavelength region of the red (R) transferred at the time T₁, is transferred to the horizontal shift register. Thereafter, the horizontal clock pulses φₕ₁ to φₕ₁₂ are successively changed unrtil a time T₄. Accordingly, the information charges accumulated in the potential well 64 (64a) formed under the horizontal transfer electrodes 34-7 and 34-11 are rearranged in a potential well 66 (66a) formed under the horizontal transfer electrode 34-3. Moreover, the information charges accumulated in the potential well 62 (62a) formed under the horizontal transfer electrode 34-1 are successively transferred to a potential well 68 (68a) formed under the horizontal transfer electrode 34-9 ahead of a horizontal transfer direction. At this time, the information charge, which has been accumulated in the potential well formed under the horizontal transfer electrode 34-1 in the output end of the horizontal shift register, is transferred to the output section 11d.

It is to be noted that the addition and the synthesis of the information charges of the horizontal shift register are not limited to this example, and there is no restriction as long as the information charges are added up and synthesized so that the information charges corresponding to the wavelength regions of different colors included in one horizontal line are not mixed. For example, in a case where the information charges included in one horizontal line correspond to different colors in the odd-numbered column and the even-numbered column of the vertical shift register as in the present embodiment, the information charges of the odd-numbered columns may be added up and synthesized separately from those of the even-numbered columns.

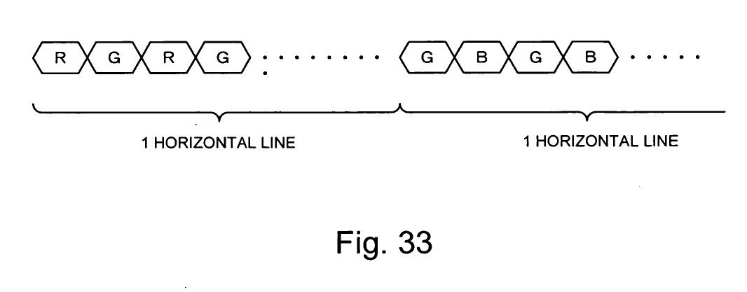

After adding up and synthesizing the information charges of one horizontal line every three pixels in this manner, two adjacent electrodes are regarded as one set among the horizontal transfer electrodes 34-1 to 34-12, and three-phase horizontal clock pulses φₕ, which are in phase with respect to one set of electrodes, are applied to thereby horizontally transfer the information charges. That is, in the present embodiment, as shown in a period of the horizontal clock pulse φ_{hc} of FIG. 31, two horizontal transfer electrodes 34-1 and 34-2, the horizontal transfer electrodes 34-3 and 34-4, the horizontal transfer electrodes 34-5 and 34-6 . . . corresponding to the vertical shift registers are regarded as sets, respectively. The substantial three-phase horizontal clock pulses φₕ₁ to φₕ₁₂ are applied to three adjacent sets of horizontal transfer electrodes to thereby add up and synthesize the information charges, and the charges are horizontally transferred. Accordingly, for a time of T₅ to T₇, the information charges accumulated in the potential wells 66, 68 are successively transferred toward the output section 11d in the horizontal transfer direction. This horizontal transfer is successively repeated to thereby convert the information charges for one horizontal line into output signals and output the signals. When the horizontal transfer of one horizontal line is completed, as shown in FIG. 30, the transfer shifts to the vertical transfer of the next horizontal line. At this time, as shown in FIG. 33, the output section 11d alternately outputs the information charges corresponding to the wavelength regions of the red (R), green (G) and blue (B) included in one horizontal line.

As described above, in the present modification, the information charges for three pixels corresponding to the wavelength region of the same color can be added up and synthesized in the horizontal transfer direction before horizontally transferred. In consequence, transfer stages can substantially be reduced, and the time for transferring the information charge during the horizontal transfer can be shortened without increasing a basic frequency of the clock pulse, unlike the conventional technology. Therefore, the image can be acquired at a high speed while a low-resolution image is acquired.

Moreover, 16-phase horizontal clock pulses φₕ are set to be controllable independently, and 16 horizontal transfer electrodes 34 connected to eight continuously arranged vertical shift registers are controlled by the horizontal clock pulse φₕ. Consequently, the information charges for four pixels can be added up and synthesized before horizontally transferred. Furthermore, in a case where the information charges for n pixels are added up, synthesized, and transferred, this transfer can be realized by supplying the horizontal clock pulses φₕ which are controllable independently of one another to the horizontal transfer electrode 34 connected to 2n continuously arranged vertical shift registers.

It is to be noted that in a case where the information charges are output as high-resolution image signals without being added up or synthesized, the horizontal shift register may be controlled by four-phase horizontal clock pulses φₕ so that the information charges are horizontally transferred every pixel in the same manner as in the conventional technology.

Moreover, the above-described vibration reduction processing can be applied to the image signal obtained from the CCD solid image pickup device 11 of the present modification. In this case, it is preferable that the image signals output from the CCD solid image pickup device 11 are associated and rearranged with the pixels of the image pickup section 11i, and the rearranged image signals are subjected to the filtering or the interpolation processing.

As described above, the vibration reduction processing can be performed using the compressed image signal obtained by adding up and synthesizing, along the transfer direction, the information charges accumulated in at least two of a plurality of potential wells. The transfer direction as the object of the compression processing may be a vertical transfer direction or a horizontal transfer direction.

Moreover, it is preferable that the pixels arranged continuously along the transfer direction are regarded as a set every predetermined number of pixels, for example, every three or more pixels, and the compressed image signal is obtained from the information charges accumulated in the remaining pixels obtained by excluding at least one pixel from the pixels included in the set. For example, to obtain the compressed image signal, the information charges may be added up and synthesized along the transfer direction.

Furthermore, the present invention is applicable to the image pickup device whose object is color image pickup. Each pixel is associated with an optical filter whose transmission wavelength region is one of two or more different wavelength regions, and receives light transmitted through the optical filter to accumulate the information charges. The pixels associated with the optical filter having each transmission wavelength region are repeatedly arranged along the transfer direction in a predetermined period. At this time, it is preferable that the pixel group included in a period is regarded as a set, the period being obtained by adding one pixel to a period in which the pixels corresponding to the optical filter having the same transmission wavelength region are arranged, and the compressed image signal is obtained from the information charges accumulated in the remaining pixels obtained by excluding at least one pixel from the pixels included in the set.

For example, a column is constituted by arranging a filter which transmits the red (R) and a filter which transmits the green (G) along the vertical transfer direction so that the filters are alternately superimposed on the light receiving pixels along the extending direction of the vertical shift register. A column is constituted by arranging the filter which transmits the green (G) and a filter which transmits the blue (B) so that the filters are alternately superimposed on the light receiving pixels along the extending direction of the vertical shift register. The columns are alternately arranged along a direction crossing the vertical transfer direction at approximately right angles to thereby arrange the pixels corresponding to the wavelengths of the red (R), the green (G) and the blue (B) in a mosaic form. Consequently, the image pickup element can be realized. In this case, three pixels arranged continuously in the vertical or horizontal transfer direction are regarded as one set, and the vibration reduction processing can be performed using the image signal compressed by adding up and synthesizing the information charges accumulated in the pixels included in one set along the transfer direction.

Moreover, it is preferable to subject the compressed image signal to extension processing. Accordingly, it is possible to calculate the signal component corresponding to the transmission wavelength region of the optical filter which is not associated with each pixel. Therefore, the vibration reduction processing can be performed with a higher precision.

Furthermore, it is preferable that the compressed image signal is subjected to the interpolation processing. The pixel having a signal value is thinned in the image signal of the compressed image frame. Therefore, the interpolation processing is performed between the thinned pixels to obtain the image frame of all the pixels (full image) so that the frame can be subjected to the vibration reduction processing.

It is to be noted that the present embodiment has been described for a case where the vibration reduction processing is performed in an image pickup device on which a solid image pickup element for color image pickup is mounted, but the vibration reduction processing can similarly be performed in an image pickup device on which a solid image pickup device for monochromatic image pickup is mounted. Even in a monochromatic image pickup, the image signal compressed in at least one of the vertical transfer direction and the horizontal transfer direction is interpolated so that the vibrations can be reduced.

Moreover, in the present embodiment, the image pickup device including the frame transfer type CCD solid image pickup element is an object, but a range in which the present invention is applied is not limited to this embodiment. The present invention is also applicable to, for example, an image pickup device including an interlace type CCD solid image pickup element.

What is claimed is:

1. An image pickup device comprising:
an image pickup element in which there is arranged a matrix of a plurality of pixels to generate and accumulate information charges in accordance with intensity of light incoming from the outside and which transfers and outputs the information charges accumulated in the pixels; and
an image signal processing section which performs vibration reduction processing with respect to an image signal output from the image pickup element,
wherein the image pickup element accumulates the information charges in a plurality of potential wells substantially separated from one another during image pickup, and transfers the information charges accumulated in at least one of the plurality of potential wells during the transfer to output a compressed image signal, and
the image signal processing section performs the vibration reduction processing by use of the compressed image signal.

2. The image pickup device according to claim 1, wherein the image pickup element adds up and synthesizes, along a transfer direction, the information charges accumulated in at least two of the plurality of potential wells to transfer the information charges.

3. The image pickup device according to claim 1, wherein the image pickup element regards the pixels arranged continuously along a transfer direction as a set every predetermined number of three or more pixels, and obtains the compressed image signal from the information charges accumulated in remaining pixels obtained by excluding at least one pixel from the pixels included in the set.

4. The image pickup device according to claim 1, wherein each pixel of the image pickup element is associated with an optical filter whose transmission wavelength region is one of two or more different wavelength regions, and receives light transmitted through the optical filter to accumulate the information charges,
the pixels associated with the optical filter having each transmission wavelength region are repeatedly arranged in a predetermined cycle along a transfer direction,
the image pickup element regards, as a set, a pixel group included in a cycle obtained by adding one pixel to a cycle in which the pixels corresponding to the optical filters having the same transmission wavelength region are arranged, and obtains the compressed image signal from the information charges accumulated in remaining pixels obtained by excluding at least one pixel from the pixels included in the set.

5. The image pickup device according to claim 3, wherein the image pickup element successively changes the pixel to be excluded from the pixels included in the set to output the compressed image signal.

6. The image pickup device according to claim 1, wherein the image signal processing section subjects the compressed image signal to expannsion processing.

7. An image signal processing unit comprises:
an image pickup section in which there is arranged a matrix of a plurality of pixels to accumulate information charges in a plurality of potential wells substantially separated from one another in accordance with intensity of light incoming from the outside during image pickup,
the image signal processing unit performing vibration reduction processing by use of a compressed image signal obtained from the information charge accumulated in at least one of the plurality of potential wells.

8. The image signal processing unit according to claim 7, wherein the vibration reduction processing is performed by use of the compressed image signal obtained by adding up and synthesizing the information charges accumulated in at least two of the plurality of potential wells along a transfer direction.

9. The image signal processing unit according to claim 7, wherein the pixels arranged continuously along a transfer direction of the image pickup element are regarded as a set every predetermined number of three or more pixels, and the compressed image signal is obtained from the information charges accumulated in remaining pixels obtained by excluding at least one pixel from the pixels included in the set.

10. The image signal processing unit according to claim 7, wherein a pixel group included in a cycle is regarded as a set, the cycle being obtained by adding one pixel to a cycle in which the pixels corresponding to optical filters having the same transmission wavelength region are arranged, and the compressed image signal is obtained from the information charges accumulated in remaining pixels obtained by excluding at least one pixel from the pixels included in the set.

11. The image signal processing unit according to claim 9, wherein the vibration reduction processing is performed using a plurality of compressed image signals obtained by successively changing the pixel to be excluded from the pixels included in the set.

12. The image signal processing unit according to claim 7, wherein the compressed image signal is subjected to expansion processing.

13. An image signal processing method comprising the steps of:
receiving an image signal output from an image pickup element including an image pickup section in which there is arranged a matrix of a plurality of pixels to accumulate information charges in a plurality of potential wells substantially separated from one another in accordance with intensity of light incoming from the outside during image pickup; and
performing vibration reduction processing by use of a compressed image signal obtained from the information charge accumulated in at least one of the plurality of potential wells.

14. The image signal processing method according to claim 13, comprising the step of:
performing the vibration reduction processing by use of the compressed image signal obtained by adding up and synthesizing the information charges accumulated in at least two of the plurality of potential wells along a transfer direction.

15. The image signal processing method according to claim 13, wherein the pixels arranged continuously along a transfer direction of the image pickup element are regarded as a set every predetermined number of three or more pixels, and the compressed image signal is obtained from the information charges accumulated in remaining pixels obtained by excluding at least one pixel from the pixels included in the set.

16. The image signal processing method according to claim 13, wherein a pixel group-included in a cycle is regarded as a set, the cycle being obtained by adding one pixel to a cycle in which the pixels corresponding to optical filters having the same transmission wavelength region are arranged, and the compressed image signal is obtained from the information charges accumulated in remaining pixels obtained by excluding at least one pixel from the pixels included in the set.

17. The image signal processing method according to claim 15, comprising the step of:
performing the vibration reduction processing by use of a plurality of compressed image signals obtained by successively changing the pixel to be excluded from the pixels included in the set.

18. The image signal processing method according to claim 13, comprising the step of:
subjecting the compressed image signal to expansion processing.

19. An image pickup device comprising:
an image pickup element in which there is arranged a matrix of a plurality of pixels to generate and accumulate information charges in accordance with intensity of light incoming from the outside and which transfers and outputs the information charges accumulated in the pixels; and
an image signal processing section which processes an image signal output from the image pickup element,
wherein the image pickup element accumulates the information charges in a plurality of potential wells substantially separated from one another during image pickup, and transfers the information charges accumulated in at least one of the plurality of potential wells during the transfer to output a plurality of compressed image signals, and
the image signal processing section synthesizes the plurality of compressed image signals.

20. The image pickup device according to claim 19, wherein the image pickup element regards the pixels arranged continuously along a transfer direction as a set every predetermined number of three or more pixels, successively changes the pixels to be included in the set, and outputs the compressed image signals from at least one of the information charges accumulated in the pixels included in the set, and
the image signal processing section synthesizes the plurality of compressed image signal in which the pixels included in the set are successively changed.
